(19) United States
(12) Patent Application Publication
(10) Pub. No.: US 2025/0219478 A1
(43) Pub. Date: Jul. 3, 2025

(54) STATOR AND MOTOR

(71) Applicant: Murata Manufacturing Co., Ltd., Nagaokakyo-shi (JP)

(72) Inventors: Kazuki IWASAKI, Nagaokakyo-shi (JP); Satoshi HIROSUE, Nagaokakyo-shi (JP); Hisato AMANO, Nagaokakyo-shi (JP); Mitsutoshi NATSUMEDA, Nagaokakyo-shi (JP); Kazuyoshi ISHIZUKA, Nagaokakyo-shi (JP); Ryosuke YAMAMOTO, Nagaokakyo-shi (JP)

(21) Appl. No.: 19/082,377

(22) Filed: Mar. 18, 2025

Related U.S. Application Data
(63) Continuation of application No. PCT/JP2023/047030, filed on Dec. 27, 2023.

(30) Foreign Application Priority Data
Jan. 16, 2023 (JP) 2023-004457

(51) Int. Cl. H02K 1/14; H02K 3/50

(52) U.S. Cl. CPC H02K 1/146; H02K 3/50

(57) ABSTRACT

A stator including: a stator core that includes an annular yoke and a tooth protruding from the yoke; a coil wound around the tooth; and a terminal member including a pillar portion extending in an axial direction of the stator core, a first fixed portion at a first end of the pillar portion and protruding toward an inner peripheral surface side of the yoke more than the pillar portion, a second fixed portion at a second end of the pillar portion and protruding toward the inner peripheral surface side of the yoke more than the pillar portion, and a terminal portion on the first fixed portion, wherein the terminal member sandwiches the yoke so that the pillar portion faces an outer peripheral surface of the yoke, the first fixed portion faces a first end face of the yoke, and the second fixed portion faces a second end face of the yoke.

### CROSS REFERENCE TO RELATED APPLICATIONS

The present application is a continuation of International application No. PCT/JP2023/047030, filed Dec. 27, 2023, which claims priority to Japanese Patent Application No. 2023-004457, filed Jan. 16, 2023, the entire contents of each of which are incorporated herein by reference.

### TECHNICAL FIELD

The present disclosure relates to a stator and a motor.

### BACKGROUND ART

Patent Document 1 discloses an electric motor including a rotor having a plurality of magnetic poles spaced apart in a circumferential direction, and a stator surrounding the rotor. The stator includes an annular stator core formed by molding magnetic powder. The stator core has an annular yoke and a plurality of teeth formed so as to protrude from the inner circumference of the yoke and spaced apart from each other across slots in the circumferential direction of the yoke. At both axial ends of the stator core, grooves for winding a coil are provided corresponding to each tooth.

Patent Document 1: Japanese Unexamined Patent Application Publication No. 2008-61408

### SUMMARY OF THE DISCLOSURE

In the electric motor described in Patent Document 1, a busbar is used to electrically lead out the coil. As illustrated in FIG. 4 and the like of Patent Document 1, the busbar to which the coil is connected is screwed to the stator core. In the electric motor described in Patent Document 1, however, additional processing is required to form a screw hole in the stator core after the stator core is manufactured, for screwing the busbar to the stator core, resulting in poor work efficiency in the process of fixing the busbar to the stator core. Furthermore, in the electric motor described in Patent Document 1, the stator core is damaged during the formation of the screw hole, leading to reduced strength of the stator core. This results in reduced fixing strength of the busbar to the stator core. The electric motor described in Patent Document 1 thus has room for improvement in terms of improving the work efficiency during attachment and the fixing strength after attachment of the busbar for electrically leading out the coil.

The present disclosure has been made to solve the above problems, and it is an object of the present disclosure to provide a stator capable of improving work efficiency during attachment and fixing strength after attachment of a terminal member for electrically leading out a coil. It is also an object of the present disclosure to provide a motor including the above stator.

A stator of the present disclosure includes: a stator core that includes an annular yoke along a circumferential direction and a tooth protruding from an inner peripheral surface of the yoke in a radial direction of the yoke, the yoke having a first end face and a second end face facing each other in an axial direction of the stator core, and the stator core comprising a compact of magnetic powder; a coil comprising a winding wound around the tooth; and a terminal member including a pillar portion extending in the axial direction of the stator core, a first fixed portion at a first end of the pillar portion in the axial direction and protruding toward an inner peripheral surface side of the yoke more than the pillar portion in the radial direction, a second fixed portion at a second end of the pillar portion in the axial direction and protruding toward the inner peripheral surface side of the yoke more than the pillar portion in the radial direction, and a terminal portion on the first fixed portion and protruding from the first fixed portion, wherein the terminal member sandwiches the yoke in the axial direction so that the pillar portion faces an outer peripheral surface of the yoke in the radial direction, the first fixed portion faces the first end face of the yoke, and the second fixed portion faces the second end face of the yoke, and a first end of the winding is wound around the terminal portion.

A motor of the present disclosure includes: the stator according to the present disclosure; and a rotor facing an inner peripheral surface of the stator.

The present disclosure can provide a stator capable of improving work efficiency during attachment and fixing strength after attachment of a terminal member for electrically leading out a coil. The present disclosure can also provide a motor including the above stator.

### BRIEF DESCRIPTION OF THE DRAWINGS

FIG. 1 is a schematic perspective view illustrating an example of a stator according to Embodiment 1 of the present disclosure.

FIG. 2 is a schematic perspective view illustrating a coil unit in FIG. 1 as viewed from the inside.

FIG. 3 is a schematic perspective view illustrating the coil unit in FIG. 1 as viewed from the outside.

FIG. 4 is a schematic perspective view illustrating a split core in FIGS. 2 and 3.

FIG. 5 is a schematic perspective view illustrating a terminal member in FIGS. 2 and 3.

FIG. 6 is a schematic cross-sectional view illustrating a part of a cross-section taken along line A-A′ of the terminal member in FIG. 5.

FIG. 7 is a schematic perspective view illustrating the stator illustrated in FIG. 1 with a housing attached thereto.

FIG. 8 is a schematic perspective view illustrating an example of a coil unit included in a stator according to Embodiment 2 of the present disclosure.

FIG. 9 is a schematic perspective view illustrating a split core in FIG. 8.

FIG. 10 is a schematic perspective view illustrating a terminal member in FIG. 8.

FIG. 11 is a schematic perspective view illustrating an example of a coil unit included in a stator according to Embodiment 3 of the present disclosure.

FIG. 12 is a schematic perspective view illustrating a split core in FIG. 11.

FIG. 13 is a schematic perspective view illustrating a terminal member in FIG. 11.

FIG. 14 is a schematic perspective view illustrating an example of a coil unit included in a stator according to Embodiment 4 of the present disclosure.

FIG. 15 is a schematic perspective view illustrating a split core in FIG. 14.

FIG. 16 is a schematic perspective view illustrating a terminal member in FIG. 14.

FIG. 17 is a schematic perspective view illustrating an example of a coil unit included in a stator according to Embodiment 5 of the present disclosure.

FIG. 18 is a schematic perspective view illustrating a split core in FIG. 17.

FIG. 19 is a schematic perspective view illustrating a terminal member in FIG. 17.

FIG. 20 is a schematic perspective view illustrating an example of a coil unit included in a stator according to Embodiment 6 of the present disclosure.

FIG. 21 is a schematic perspective view illustrating a split core in FIG. 20.

FIG. 22 is a schematic perspective view illustrating a terminal member in FIG. 20.

FIG. 23 is a schematic perspective view illustrating an example of a coil unit included in a stator according to Embodiment 7 of the present disclosure.

FIG. 24 is a schematic perspective view illustrating a split core in FIG. 23.

FIG. 25 is a schematic perspective view illustrating a terminal member in FIG. 23.

FIG. 26 is a schematic perspective view illustrating an example of a coil unit included in a stator according to Embodiment 8 of the present disclosure.

FIG. 27 is a schematic perspective view illustrating a split core in FIG. 26.

FIG. 28 is a schematic perspective view illustrating a terminal member in FIG. 26.

FIG. 29 is a schematic perspective view illustrating an example of a stator according to Embodiment 9 of the present disclosure.

FIG. 30 is a schematic perspective view illustrating an example of a motor according to the present disclosure.

### DESCRIPTION OF PREFERRED EMBODIMENTS

A stator and a motor according to the present disclosure will be described below. Note that the present disclosure is not limited to the following configurations, and may be modified as appropriate without departing from the scope of the present disclosure. The present disclosure also includes combinations of two or more individual preferable configurations of the present disclosure described below.

Each embodiment described below is an example, and it goes without saying that partial replacement or combination of configurations described in different embodiments is possible. In Embodiment 2 and subsequent embodiments, the description of matters common to Embodiment 1 will be omitted, and only different points will be described. In particular, similar effects of similar configurations will not be described in each embodiment.

In the following description, the respective embodiments will be simply referred to as a “stator of the present disclosure” and a “motor of the present disclosure” unless there is any particular distinction therebetween.

The drawings illustrated below are schematic drawings, and dimensions, aspect ratios, and the like therein may be different from those of an actual product.

In the present specification, a term indicating a relationship between elements (such as “parallel” and “orthogonal”, for example) and a term indicating a shape of an element do not only mean a literal, strict aspect but also mean a substantially equivalent range, for example, a range including a difference of about several %.

### Stator

A stator of the present disclosure includes: a stator core that includes an annular yoke along a circumferential direction and a tooth protruding from an inner peripheral surface of the yoke in a radial direction of the yoke, and is made of a compact of magnetic powder; a coil made of a winding wound around the tooth; and a terminal member including a pillar portion extending in an axial direction of the stator core, a first fixed portion provided at one end portion of the pillar portion in the axial direction so as to protrude toward the inner peripheral surface side of the yoke more than the pillar portion in the radial direction, a second fixed portion provided at the other end portion of the pillar portion in the axial direction so as to protrude toward the inner peripheral surface side of the yoke more than the pillar portion in the radial direction, and a terminal portion provided on the first fixed portion so as to protrude from the first fixed portion, the yoke has a first end face and a second end face facing each other in the axial direction, the terminal member sandwiches the yoke in the axial direction so that the pillar portion faces an outer peripheral surface of the yoke in the radial direction, the first fixed portion faces the first end face of the yoke, and the second fixed portion faces the second end face of the yoke, and one end portion of the winding is fixed in a state of being wound around the terminal portion.

### Embodiment 1

In a stator according to Embodiment 1 of the present disclosure, a first end face of a yoke is fitted to a first fixed portion. More specifically, in the stator according to Embodiment 1 of the present disclosure, a first groove is provided in the first end face of the yoke so as to have an opening on the outer peripheral surface side of the yoke in a radial direction, and the first groove is fitted to the first fixed portion.

In the stator according to Embodiment 1 of the present disclosure, a second end face of the yoke is fitted to a second fixed portion. More specifically, in the stator according to Embodiment 1 of the present disclosure, a second groove is provided in the second end face of the yoke so as to have an opening on the outer peripheral surface side of the yoke in the radial direction, and the second groove is fitted to the second fixed portion.

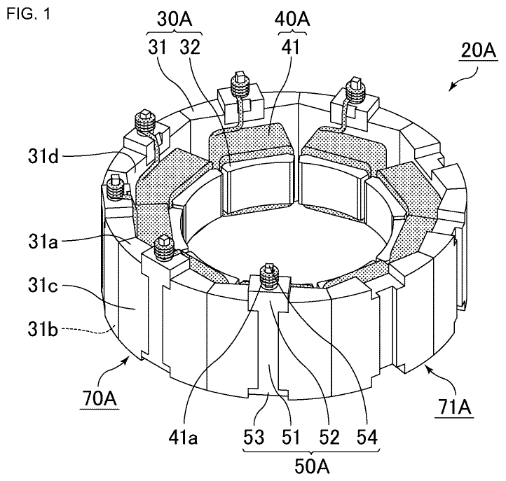

FIG. 1 is a schematic perspective view illustrating an example of the stator according to Embodiment 1 of the present disclosure.

A stator 20A illustrated in FIG. 1 includes a stator core 30A, a plurality of coils 40A, and a plurality of terminal members 50A.

The stator core 30A has a yoke (also called a core back) 31 and a plurality of teeth 32.

In the present specification, a direction in which the axis of the stator core extends is defined as an axial direction. A direction along the outer peripheral surface of the yoke when viewed from the axial direction is defined as a circumferential direction. Furthermore, a direction orthogonal to the axial direction, in which the outer peripheral surface and an inner peripheral surface of the yoke face each other is defined as the radial direction.

The yoke 31 has an annular shape along the circumferential direction.

The yoke 31 has a first end face 31a and a second end face 31b that face each other in the axial direction.

The yoke 31 has an outer peripheral surface 31c and an inner peripheral surface 31d that face each other in the radial direction.

The teeth 32 protrude from the inner peripheral surface 31d of the yoke 31 in the radial direction of the yoke 31 independently of one another so as to be spaced apart from one another in the circumferential direction. The teeth 32 are thus integrated with the yoke 31.

In the present specification, the expression that “two elements are integrated” means that there is no interface between the elements, for example, the boundary between the elements cannot be discerned.

The stator core 30A is made of a compact of magnetic powder. Specifically, the yoke 31 and the teeth 32 are integrally formed of a compact of magnetic powder.

The stator core 30A is preferably made of a powder magnetic core. Specifically, the yoke 31 and the teeth 32 are preferably integrally formed of a powder magnetic core.

The stator core 30A may be made of a compact of a composite material containing magnetic powder and resin, instead of the powder magnetic core.

The plurality of coils 40A are each formed of a winding 41 wound around the tooth 32. The plurality of coils 40A are each provided independently on the tooth 32 so as to be spaced apart from each other in the circumferential direction.

The coils 40A are each insulated from the tooth 32 with an insulating member to be described later, for example, interposed therebetween.

The windings 41 of the plurality of coils 40A are connected in series, for example.

Examples of the winding 41 include polyurethane copper wire (UEW) and the like.

The plurality of terminal members 50A each include a pillar portion 51, a first fixed portion 52, a second fixed portion 53, and a terminal portion 54.

The pillar portion 51 extends in the axial direction.

The first fixed portion 52 is provided at one end portion of the pillar portion 51 in the axial direction (the upper end portion of the pillar portion 51 in FIG. 1) so as to protrude toward the inner peripheral surface 31d of the yoke 31 more than the pillar portion 51 in the radial direction.

The first fixed portion 52 may protrude more than the pillar portion 51 in the circumferential direction as illustrated in FIG. 1, or does not have to protrude more than the pillar portion 51.

The first fixed portion 52 may be integrated with the pillar portion 51. In this case, the first fixed portion 52 is integrally molded with the pillar portion 51, for example.

The first fixed portion 52 does not have to be integrated with the pillar portion 51. In this case, the first fixed portion 52 is fixed to the pillar portion 51 by joining or the like as a separate member from the pillar portion 51, for example.

From the viewpoint of manufacturing efficiency of the terminal member 50A, it is preferable that the first fixed portion 52 is integrated with the pillar portion 51.

The second fixed portion 53 is provided at the other end portion of the pillar portion 51 in the axial direction (the lower end portion of the pillar portion 51 in FIG. 1) so as to protrude toward the inner peripheral surface 31d of the yoke 31 more than the pillar portion 51 in the radial direction.

The second fixed portion 53 may protrude more than the pillar portion 51 in the circumferential direction as illustrated in FIG. 1, or does not have to protrude more than the pillar portion 51.

The second fixed portion 53 may be integrated with the pillar portion 51. In this case, the second fixed portion 53 is integrally molded with the pillar portion 51, for example.

The second fixed portion 53 does not have to be integrated with the pillar portion 51. In this case, the second fixed portion 53 is fixed to the pillar portion 51 by joining or the like as a separate member from the pillar portion 51, for example.

From the viewpoint of manufacturing efficiency of the terminal member 50A, it is preferable that the second fixed portion 53 is integrated with the pillar portion 51.

It is preferable that the pillar portion 51, the first fixed portion 52, and the second fixed portion 53 are each independently made of an insulating material.

Examples of the insulating material to form the pillar portion 51, the first fixed portion 52, and the second fixed portion 53 include resins such as nylon and polyphenylene sulfide (PPS).

The pillar portion 51, the first fixed portion 52, and the second fixed portion 53 may be made of the same material, different materials from each other, or partially different materials.

In the example illustrated in FIG. 1, the terminal member 50A has one terminal portion 54.

The terminal portion 54 is provided on the first fixed portion 52 so as to protrude from the first fixed portion 52.

The terminal portion 54 preferably protrudes from the first fixed portion 52 toward the opposite side to the second fixed portion 53 in the axial direction.

The terminal portion 54 may be integrated with the first fixed portion 52. In this case, the terminal portion 54 is integrally molded with the first fixed portion 52, for example.

The terminal portion 54 does not have to be integrated with the first fixed portion 52. In this case, the terminal portion 54 is fixed to the first fixed portion 52 by press-fitting or the like as a separate member from the first fixed portion 52, for example.

The terminal portion 54 is preferably made of a conductive material. In this case, one end portion 41a of the winding 41 to be described later and a terminal of a connection board can be easily connected through the terminal portion 54.

Examples of the conductive material to form the terminal portion 54 include metal such as phosphor bronze, and the like.

The terminal portion 54 may be made of an insulating material. In this case, there is no need to consider insulation between the terminal portion 54 and the stator core 30A. This improves the degree of freedom in arrangement of the terminal portion 54 relative to the first fixed portion 52.

Examples of the insulating material to form the terminal portion 54 include resins such as nylon and polyphenylene sulfide.

Examples of the three-dimensional shape of the terminal portion 54 include a rectangular column shape, a cylindrical shape, and the like.

The terminal member 50A sandwiches the yoke 31 in the axial direction so that the pillar portion 51 faces the outer peripheral surface 31c of the yoke 31, the first fixed portion 52 faces the first end face 31a of the yoke 31, and the second fixed portion 53 faces the second end face 31b of the yoke 31.

In the stator 20A, the terminal member 50A is configured to sandwich the yoke 31 in the axial direction. This makes it possible to easily attach the terminal member 50A to the yoke 31 without additional processing such as forming a screw hole in the yoke 31 as in Patent Document 1, for example. This results in improved work efficiency when attaching the terminal member 50A.

In the stator 20A, the terminal member 50A is attached so as to sandwich the yoke 31 in the axial direction. This leads to improved fixing strength after attachment of the terminal member 50A. In the stator 20A, the improved fixing strength after attachment of the terminal member 50A also improves the reliability.

An insulating member may be provided between the yoke 31 and the terminal member 50A. This makes it easier to ensure insulation between the yoke 31 and the terminal member 50A, particularly between the yoke 31 and the terminal portion 54.

The insulating member may be an insulating film that covers at least one of the yoke 31 and the terminal member 50A.

When the yoke 31 is covered with an insulating film, it is preferable that the surface of the yoke 31 facing the terminal member 50A is covered with the insulating film, and it is more preferable that the entire surface of the yoke 31 is covered with the insulating film.

When the surface of the yoke 31 facing the terminal member 50A is covered with an insulating film, the entire surface of the yoke 31 does not have to be covered with the insulating film.

When the terminal member 50A is covered with an insulating film, it is preferable that the surfaces of the pillar portion 51, the first fixed portion 52, and the second fixed portion 53 facing the yoke 31 are covered with the insulating film, and it is more preferable that the entire surfaces of the pillar portion 51, the first fixed portion 52, and the second fixed portion 53 are covered with the insulating film.

When the surfaces of the pillar portion 51, the first fixed portion 52, and the second fixed portion 53 facing the yoke 31 are covered with an insulating film, the entire surfaces of the pillar portion 51, the first fixed portion 52, and the second fixed portion 53 do not have to be covered with the insulating film.

Examples of a method for covering at least one of the target surfaces of the yoke 31 and the terminal member 50A with an insulating film include a method of applying an insulating material onto the target surface by a coating method such as electrodeposition coating.

The insulating member may be an insulating sheet formed of an insulating material in advance. In this case, the insulating sheet is provided at least between the yoke 31 and the terminal member 50A.

When the pillar portion 51, the first fixed portion 52, and the second fixed portion 53 are made of the insulating material as described above, an insulating member does not have to be provided between the yoke 31 and the terminal member 50A. However, when the terminal portion 54 is exposed from the surface of the first fixed portion 52 facing the yoke 31, for example, it is preferable that an insulating member is provided between the yoke 31 and the exposed portion of the terminal portion 54 described above.

The one end portion 41a of the winding 41 is fixed to the terminal portion 54 in a state of being wound around the terminal portion 54. The one end portion 41a of the winding 41 is thus led out to the terminal member 50A.

The one end portion 41a of the winding 41 may be wound around the terminal portion 54 and then fixed to the terminal portion 54 by soldering or the like. Alternatively, the one end portion 41a of the winding 41 may be wound around the terminal portion 54 and then fixed to the terminal portion 54 and a terminal of a connection board to be described later by soldering or the like.

In the stator 20A, at least one of the plurality of coils 40A may have one end portion 41a of the winding 41 fixed in a state of being wound around the terminal portion 54. Specifically, the one end portions 41a of the windings 41 of all of the plurality of coils 40A may be fixed in the state of being wound around the terminal portion 54. Alternatively, the one end portions 41a of the windings 41 of some of the coils 40A may be fixed in the state of being wound around the terminal portion 54. When the one end portions 41a of the windings 41 of some of the plurality of coils 40A are fixed in the state of being wound around the terminal portion 54, the one end portions 41a of the windings 41 of the remaining coils 40A do not have to be fixed in the state of being wound around the terminal portion 54.

As described above, in the stator 20A, the terminal members 50A that sandwich the yoke 31 in the axial direction are used to electrically lead out the coil 40A, for example, to electrically lead out the coil 40A for electrical connection to the connection board to be described later.

The stator 20A can thus improve the work efficiency during attachment and fixing strength after attachment of the terminal members 50A for electrically leading out the coil 40A.

During manufacture of the stator 20A, there is no need to perform additional processing on the molded stator core 30A (more specifically, yoke 31) in order to attach the terminal members 50A to the yoke 31. This prevents the stator core 30A from being damaged during manufacture of the stator 20A. As a result, a decrease in strength of the stator 20A (more specifically, the stator core 30A) is suppressed.

Furthermore, in the stator 20A, the terminal members 50A are attached so as to sandwich the yoke 31 in the axial direction. This prevents the terminal members 50A from reducing a space factor of the coil 40A (winding 41), thereby ensuring the output density of a motor including the stator 20A.

Hereinafter, a stator having a plurality of coil units arranged in an annular pattern in the circumferential direction will be taken as an example of the stator according to Embodiment 1 of the present disclosure, and a mode of fixing a terminal member in each coil unit will be described.

As illustrated in FIG. 1, the stator 20A is formed by arranging a plurality of coil units, including a coil unit 70A and a coil unit 71A, in an annular shape in the circumferential direction.

In the stator 20A, the coil unit 70A is used to connect the windings 41 of the plurality of coils 40A in series, for example. In this case, as illustrated in FIG. 1, the stator 20A may further include the coil unit 71A that is not provided with the terminal member 50A, in addition to the coil unit 70A. This eliminates the need to provide the terminal members 50A for all the coil units, making it possible to reduce the cost for the terminal members 50A.

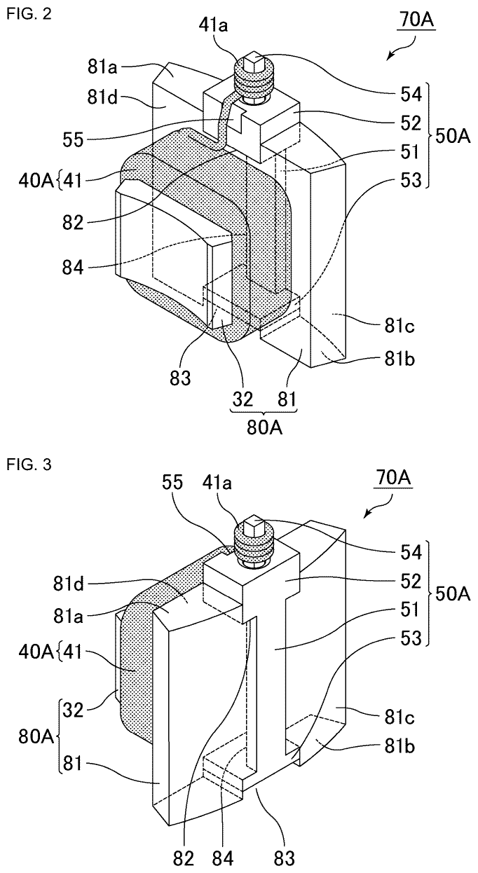

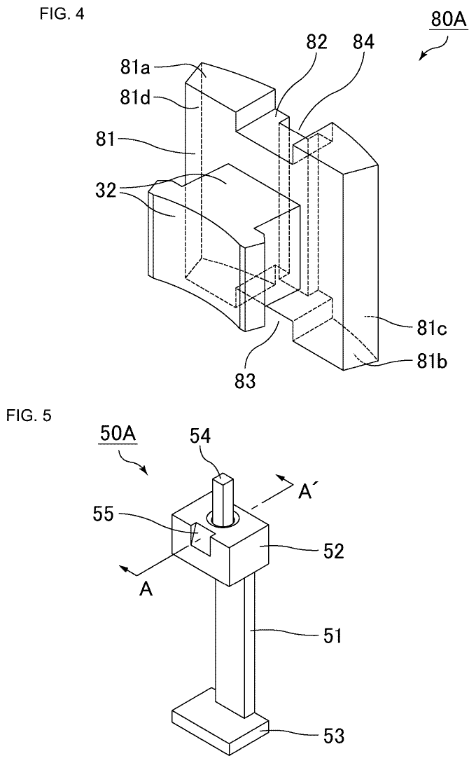

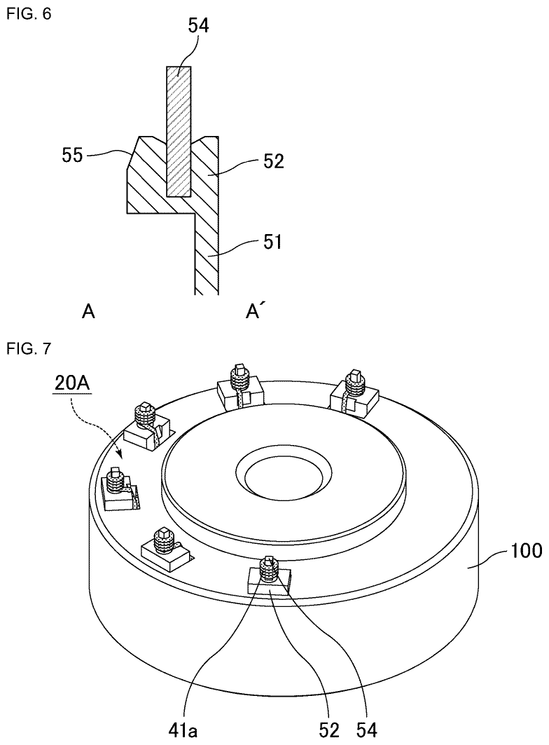

FIG. 2 is a schematic perspective view illustrating the coil unit in FIG. 1 as viewed from the inside. FIG. 3 is a schematic perspective view illustrating the coil unit in FIG. 1 as viewed from the outside. FIG. 4 is a schematic perspective view illustrating a split core in FIGS. 2 and 3. FIG. 5 is a schematic perspective view illustrating the terminal member in FIGS. 2 and 3. FIG. 6 is a schematic cross-sectional view illustrating a part of a cross-section taken along line A-A′ of the terminal member in FIG. 5.

The coil unit 70A illustrated in FIGS. 2 and 3 includes a split core 80A, the coil 40A, and the terminal member 50A.

The split core 80A is formed by dividing the stator core 30A in the circumferential direction. In other words, the stator core 30A is formed by arranging a plurality of split cores 80A in an annular shape in the circumferential direction.

The split core 80A has a split yoke 81 and a tooth 32.

The split yoke 81 is formed by dividing the yoke 31 in the circumferential direction.

The split yoke 81 has a first end face 81a and a second end face 81b that face each other in the axial direction. The first end face 81a of the split yoke 81 is included in the first end face 31a of the yoke 31. The second end face 81b of the split yoke 81 is included in the second end face 31b of the yoke 31.

The split yoke 81 has an outer peripheral surface 81c and an inner peripheral surface 81d that face each other in the radial direction. The outer peripheral surface 81c of the split yoke 81 is included in the outer peripheral surface 31c of the yoke 31. The inner peripheral surface 81d of the split yoke 81 is included in the inner peripheral surface 31d of the yoke 31.

The tooth 32 protrudes in the radial direction from the inner peripheral surface 81d of the split yoke 81. The tooth 32 is thus integrated with the split yoke 81.

The split core 80A is made of a compact of magnetic powder. Specifically, the split yoke 81 and the tooth 32 of the split core 80A are integrally formed of a compact of magnetic powder.

When viewed from the axial direction, the outer periphery of the split core 80A along the circumferential direction, that is, the outer periphery of the split yoke 81 along the circumferential direction may be formed of, for example, a curved line only, a straight line only, or a combination of the curved line and straight line. The mode in which the split yokes 81, each having the outer periphery thus configured when viewed from the axial direction, are arranged in the circumferential direction is included in the mode in which the yoke 31 has the annular shape along the circumferential direction.

In the split core 80A, it is preferable that the tooth 32 is narrower on the split yoke 81 side than on the opposite side to the split yoke 81 in at least one of the axial direction and the circumferential direction. In the example illustrated in FIG. 4, the tooth 32 is narrower in the circumferential direction on the split yoke 81 side than on the opposite side to the split yoke 81.

Therefore, in the stator core 30A having the plurality of split cores 80A arranged in the annular shape in the circumferential direction, the teeth 32 are preferably narrower on the yoke 31 side than on the opposite side to the yoke 31 in at least one of the axial direction and the circumferential direction.

When parts of the teeth 32 on the yoke 31 side (split yoke 81 side) are narrower than on the opposite side to the yoke 31 (opposite side to the split yoke 81), the number of turns of the coil 40A can be increased by using such a narrow part as the winding axis of the coil 40A. This makes it easier for a magnetic flux penetrating the coil 40A to increase in a motor including the stator 20A. The output torque of the motor is thus easily improved. The coil 40A is provided on the tooth 32 of the split core 80A.

In the terminal member 50A, the terminal portion 54 may penetrate the first fixed portion 52 in the axial direction, or does not have to penetrate the first fixed portion 52 in the axial direction as illustrated in FIG. 6.

The terminal member 50A sandwiches the split yoke 81 in the axial direction so that the pillar portion 51 faces the outer peripheral surface 81c of the split yoke 81, the first fixed portion 52 faces the first end face 81a of the split yoke 81, and the second fixed portion 53 faces the second end face 81b of the split yoke 81. The terminal member 50A is thus fixed to the split yoke 81.

A specific mode of fixing the terminal member 50A in the coil unit 70A will be described below.

As illustrated in FIGS. 2, 3, and 4, the first end face 81a of the split yoke 81 is provided with a first groove 82 having an opening on the outer peripheral surface 81c side of the split yoke 81 in the radial direction.

The first groove 82 may be provided so as to have an opening at least on the outer peripheral surface 81c side of the split yoke 81 in the radial direction.

The first groove 82 may be provided so as to have an opening across both the outer peripheral surface 81c side and the inner peripheral surface 81d side of the split yoke 81 in the radial direction. More specifically, the first groove 82 may be provided so as to connect the outer peripheral surface 81c and the inner peripheral surface 81d of the split yoke 81 in the radial direction.

Alternatively, the first groove 82 may be provided in the radial direction from the outer peripheral surface 81c of the split yoke 81 to the middle of the direction toward the inner peripheral surface 81d, without having an opening on the inner peripheral surface 81d side of the split yoke 81.

The three-dimensional shape of the first groove 82 is not limited to the three-dimensional shape illustrated in FIG. 4.

As illustrated in FIGS. 2 and 3, the first end face 81a of the split yoke 81 is fitted to the first fixed portion 52. More specifically, the first groove 82 provided in the first end face 81a of the split yoke 81 is fitted to the first fixed portion 52. This allows the first fixed portion 52 to be firmly fixed to the split yoke 81, and facilitates positioning of the first fixed portion 52 in the axial direction and the circumferential direction.

As illustrated in FIGS. 2, 3, and 4, the second end face 81b of the split yoke 81 is provided with a second groove 83 having an opening on the outer peripheral surface 81c side of the split yoke 81 in the radial direction.

The second groove 83 may be provided so as to have an opening at least on the outer peripheral surface 81c side of the split yoke 81 in the radial direction.

The second groove 83 may be provided so as to have an opening across both the outer peripheral surface 81c side and the inner peripheral surface 81d side of the split yoke 81 in the radial direction. More specifically, the second groove 83 may be provided so as to connect the outer peripheral surface 81c and the inner peripheral surface 81d of the split yoke 81 in the radial direction.

Alternatively, the second groove 83 may be provided in the radial direction from the outer peripheral surface 81c of the split yoke 81 to the middle of the direction toward the inner peripheral surface 81d, without having an opening on the inner peripheral surface 81d side of the split yoke 81.

The three-dimensional shape of the second groove 83 is not limited to the three-dimensional shape illustrated in FIG. 4.

As illustrated in FIGS. 2 and 3, the second end face 81b of the split yoke 81 is fitted to the second fixed portion 53. More specifically, the second groove 83 provided in the second end face 81b of the split yoke 81 is fitted to the second fixed portion 53. This allows the second fixed portion 53 to be firmly fixed to the split yoke 81, and facilitates positioning of the second fixed portion 53 in the axial direction and the circumferential direction.

As described above, in the coil unit 70A, the first groove 82 is fitted to the first fixed portion 52, and the second groove 83 is fitted to the second fixed portion 53. This allows the terminal member 50A to be firmly fixed to the split yoke 81, and facilitates positioning of the terminal member 50A in the axial and circumferential directions.

When a busbar is screwed to a stator core as in the electric motor described in Patent Document 1, additional processing is required to form a screw hole in the stator core after the stator core is manufactured, resulting in reduced manufacturing efficiency. Furthermore, the stator core is damaged during the formation of the screw hole, resulting in reduced strength of the stator core. When the stator core is made of a powder magnetic core, for example, it is difficult to form a screw hole in the stator core because the powder magnetic core is brittle.

In the coil unit 70A, on the other hand, the first groove 82 provided in the first end face 81a of the split yoke 81 and the second groove 83 provided in the second end face 81b of the split yoke 81 are formed simultaneously with the formation of the split core 80A. Specifically, during manufacture of the coil unit 70A, no additional processing needs to be performed on the formed split core 80A, in order to provide the first groove 82 and the second groove 83 in the split yoke 81. This prevents a decrease in the manufacturing efficiency of the coil unit 70A.

Furthermore, during manufacture of the coil unit 70A, no additional processing needs to be performed on the formed split core 80A, in order to provide the first groove 82 and the second groove 83 in the split yoke 81. This prevents damage to the split core 80A. As a result, a decrease in the strength of the coil unit 70A (more specifically, the split core 80A) is prevented.

In the coil unit 70A, the first groove 82 and the second groove 83 provided in the split yoke 81 function when fitting the first end face 81a of the split yoke 81 to the first fixed portion 52 and when fitting the second end face 81b of the split yoke 81 to the second fixed portion 53, even when they are shallower than the screw hole described in Patent Document 1. Therefore, in the coil unit 70A, even when the split yoke 81 is provided with the first groove 82 and the second groove 83, the influence on magnetic characteristics is minimized.

As illustrated in FIGS. 2 and 3, the first fixed portion 52 may protrude from the first groove 82 in the axial direction. This makes it easier to ensure the distance between the split yoke 81 and the terminal portion 54 in the coil unit 70A. Therefore, the insulation between the split yoke 81 and the terminal portion 54 is easily ensured.

FIG. 7 is a schematic perspective view illustrating the stator illustrated in FIG. 1 with a housing attached thereto.

As illustrated in FIG. 7, when the first fixed portion 52 protrudes in the axial direction from the first groove 82 (see FIGS. 2 and 3 or the like) in a state where a housing (also called a motor case) 100 for protecting the stator core 30A is attached to the stator 20A, the distance between the terminal portion 54 and the housing 100 is easily ensured. This makes it easier to ensure the insulation between the terminal portion 54 and the housing 100.

As illustrated in FIGS. 2, 3, 5, and 6, the first fixed portion 52 is preferably provided with a guide groove 55. In the example illustrated in FIGS. 2 and 3, the guide groove 55 is provided in the surface of the first fixed portion 52 on the inner peripheral surface 81d side of the split yoke 81.

As illustrated in FIGS. 2 and 3, the winding 41 preferably extends toward the terminal portion 54 so as to pass through the guide groove 55 on the one end portion 41a side. Specifically, the guide groove 55 is used as a groove for arranging the winding 41 when leading out the one end portion 41a of the winding 41 to the terminal portion 54.

At the boundary between adjacent surfaces of the split yoke 81, for example, the boundary between the first end face 81a and the inner peripheral surface 81d of the split yoke 81, roughness increases during the manufacturing process of the split core 80A, and burrs may be formed. Therefore, when the one end portion 41a side of the winding 41 is in contact with the boundary between the first end face 81a and the inner peripheral surface 81d of the split yoke 81 when leading out the one end portion 41a of the winding 41 to the terminal portion 54, the insulating coating of the winding 41 may be damaged by the burrs described above.

In the coil unit 70A, on the other hand, when the winding 41 extends toward the terminal portion 54 so as to pass through the guide groove 55 on the one end portion 41a side, the one end portion 41a side of the winding 41 can avoid the boundary between the first end face 81a and the inner peripheral surface 81d of the split yoke 81 when leading out the one end portion 41a of the winding 41 to the terminal portion 54. This prevents damage to the insulating coating of the winding 41.

Furthermore, in the coil unit 70A, when the winding 41 extends toward the terminal portion 54 so as to pass through the guide groove 55 on the one end portion 41a side, the one end portion 41a side of the winding 41 is less likely to come into contact with the housing 100 in a state where the housing 100 is attached to the stator 20A as illustrated in FIG. 7. This makes it easier to ensure the insulation between the winding 41 and the housing 100.

As illustrated in FIG. 4, the outer peripheral surface 81c of the split yoke 81 is preferably provided with a third groove 84 extending in the axial direction.

As illustrated in FIG. 4, the third groove 84 is preferably provided so as to have an opening across both the first end face 81a side and the second end face 81b side of the split yoke 81 in the axial direction. Here, the third groove 84 is preferably provided so as to have an opening across both the first groove 82 side and the second groove 83 side. More specifically, the third groove 84 is preferably provided so as to connect the first end face 81a and the second end face 81b of the split yoke 81 in the axial direction. Here, the third groove 84 is preferably provided so as to connect the first groove 82 and the second groove 83.

The three-dimensional shape of the third groove 84 is not limited to the three-dimensional shape illustrated in FIG. 4.

As illustrated in FIGS. 2 and 3, the outer peripheral surface 81c of the split yoke 81 is preferably fitted to the pillar portion 51. More specifically, it is preferable that the third groove 84 provided in the outer peripheral surface 81c of the split yoke 81 is fitted to the pillar portion 51. The pillar portion 51 is thus firmly fixed to the split yoke 81, facilitating positioning of the pillar portion 51 in the circumferential direction and the radial direction.

In the coil unit 70A, the first groove 82 is fitted to the first fixed portion 52, the second groove 83 is fitted to the second fixed portion 53, and the third groove 84 is fitted to the pillar portion 51. The terminal member 50A is thus firmly fixed to the split yoke 81, facilitating positioning of the terminal member 50A in the axial, circumferential, and radial directions.

In the split core 80A of the coil unit 70A, when the third groove 84 is provided in the outer peripheral surface 81c of the split yoke 81, the third groove 84 is formed simultaneously with the formation of the split core 80A, as with the first groove 82 and the second groove 83. Specifically, during manufacture of the coil unit 70A, no additional processing needs to be performed on the formed split core 80A, in order to provide the first groove 82, the second groove 83, and the third groove 84 in the split yoke 81. This prevents a decrease in the manufacturing efficiency of the coil unit 70A.

Furthermore, during manufacture of the coil unit 70A, no additional processing needs to be performed on the formed split core 80A, in order to provide the first groove 82, the second groove 83, and the third groove 84 in the split yoke 81. This prevents damage to the split core 80A. As a result, a decrease in the strength of the coil unit 70A (more specifically, the split core 80A) is prevented.

In the coil unit 70A, the third groove 84 provided in the split yoke 81 functions when fitting the outer peripheral surface 81c of the split yoke 81 to the pillar portion 51, even when the third groove is shallower than the screw hole described in Patent Document 1. Therefore, in the coil unit 70A, even when the split yoke 81 is provided with the third groove 84, the influence on the magnetic characteristics is minimized.

As illustrated in FIG. 3, in the coil unit 70A, it is preferable that the terminal member 50A, here, the pillar portion 51, the first fixed portion 52, and the second fixed portion 53 do not protrude from the outer peripheral surface 81c of the split yoke 81 in the radial direction. This suppresses an increase in the radial dimension of the coil unit 70A even when the terminal member 50A is provided.

In the coil unit 70A, as a configuration in which the terminal member 50A does not protrude from the outer peripheral surface 81c of the split yoke 81 in the radial direction, the outer end of the terminal member 50A may be located at the same position as the outer peripheral surface 81c of the split yoke 81 or may be located on the inner peripheral surface 81d side of the split yoke 81 in the radial direction.

As illustrated in FIG. 2, in the coil unit 70A, it is preferable that the terminal member 50A, here, the first fixed portion 52 and the second fixed portion 53 do not protrude from the inner peripheral surface 81d of the split yoke 81 in the radial direction. This prevents the terminal member 50A from interfering with the coil 40A (winding 41) even when the terminal member 50A is provided. The terminal member 50A is therefore prevented from reducing the space factor of the coil 40A (winding 41).

In the coil unit 70A, as a configuration in which the terminal member 50A does not protrude from the inner peripheral surface 81d of the split yoke 81 in the radial direction, the inner end of the terminal member 50A may be located at the same position as the inner peripheral surface 81d of the split yoke 81 or may be located on the outer peripheral surface 81c side of the split yoke 81 in the radial direction.

### Embodiment 2

In a stator according to Embodiment 2 of the present disclosure, a first fixed portion fits inside a first groove in the axial direction.

The stator according to Embodiment 2 of the present disclosure may be the same as the stator according to Embodiment 1 of the present disclosure, except for the above point.

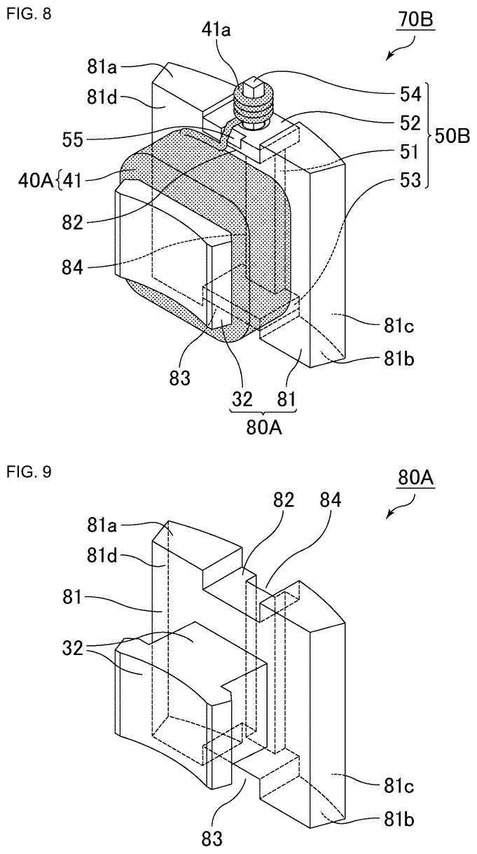

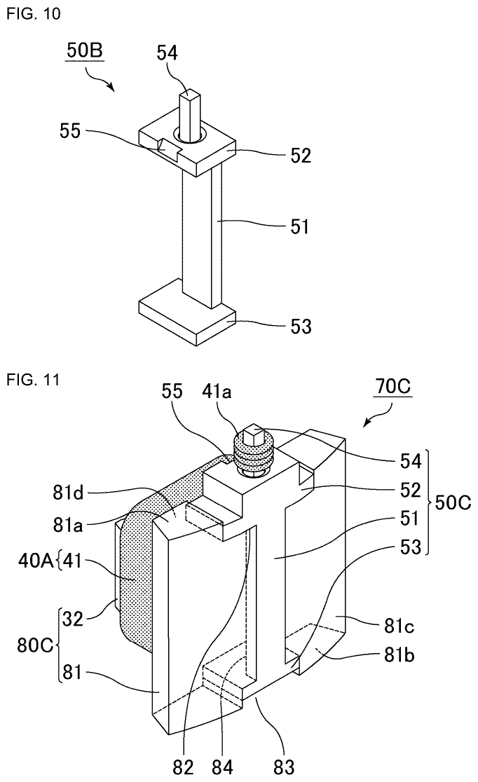

FIG. 8 is a schematic perspective view illustrating an example of a coil unit included in the stator according to Embodiment 2 of the present disclosure. FIG. 9 is a schematic perspective view illustrating a split core in FIG. 8. FIG. 10 is a schematic perspective view illustrating a terminal member in FIG. 8.

A coil unit 70B illustrated in FIG. 8 includes a split core 80A (see FIG. 9), a coil 40A, and a terminal member 50B (see FIG. 10).

As illustrated in FIG. 8, a first fixed portion 52 fits inside a first groove 82 in the axial direction. Specifically, the first fixed portion 52 does not protrude from the first groove 82 in the axial direction. In such a case, the outer end of the first fixed portion 52 may be located at the same position as the outer end of the first groove 82 or may be located on the inner end (bottom) side of the first groove 82 in the axial direction.

In the coil unit 70B, the first fixed portion 52 fits inside the first groove 82 in the axial direction, thus suppressing an increase in the axial dimension of the coil unit 70B. Therefore, a stator having a plurality of the coil units 70B arranged in an annular shape in the circumferential direction and a motor including this stator can be easily reduced in height.

In the coil unit 70B, the axial dimension of the first groove 82 in FIG. 9 is the same as in FIG. 4 and the axial dimension of the first fixed portion 52 in FIG. 10 is smaller than that in FIG. 5, so that the first fixed portion 52 is accommodated inside the first groove 82 in the axial direction. However, the present disclosure is not limited to this configuration. For example, the axial dimension of the first fixed portion 52 may be the same as in FIG. 5, while the axial dimension of the first groove 82 may be larger than that in FIG. 4, so that the first fixed portion 52 fits inside the first groove 82 in the axial direction.

In Embodiments 1 and 2, the second fixed portion 53 may protrude from the second groove 83 in the axial direction, or may fit inside the second groove 83 in the axial direction. The same applies to other embodiments.

### Embodiment 3

In a stator according to Embodiment 3 of the present disclosure, a first groove is provided in a first end face of a yoke so as to having an opening on the outer peripheral surface side of the yoke in the radial direction, and the first groove is fitted to a first fixed portion. A second groove is provided in a second end face of the yoke so as to have an opening on the outer peripheral surface side of the yoke in the radial direction, and the second groove is fitted to a second fixed portion. The first groove and the second groove are different from each other in three-dimensional shape.

In the stator according to Embodiment 3 of the present disclosure, the first groove and the second groove are different from each other in maximum circumferential dimension.

In the stator according to Embodiment 3 of the present disclosure, the maximum circumferential dimension of the first groove is larger than the maximum circumferential dimension of the second groove.

The stator according to Embodiment 3 of the present disclosure may be the same as the stators according to Embodiments 1 and 2 of the present disclosure, except for the above points.

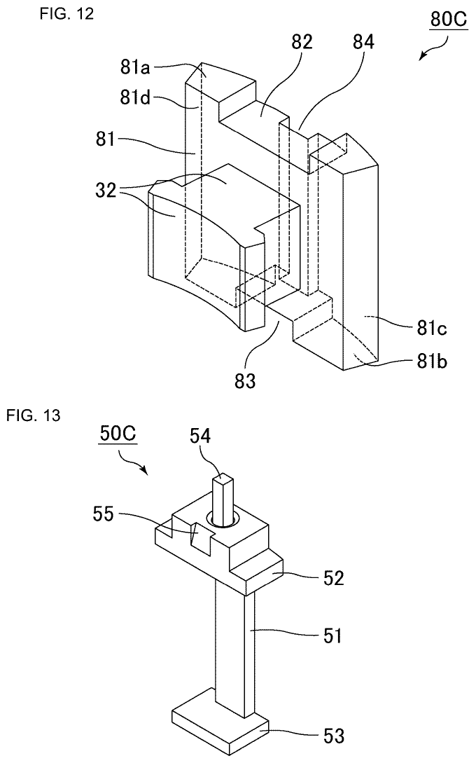

FIG. 11 is a schematic perspective view illustrating an example of a coil unit included in the stator according to Embodiment 3 of the present disclosure. FIG. 12 is a schematic perspective view illustrating a split core in FIG. 11. FIG. 13 is a schematic perspective view illustrating a terminal member in FIG. 11.

A coil unit 70C illustrated in FIG. 11 includes a split core 80C (see FIG. 12), a coil 40A, and a terminal member 50C (see FIG. 13).

As illustrated in FIGS. 11 and 12, a first groove 82 and a second groove 83 are different from each other in three-dimensional shape. This makes it easy to distinguish between the first groove 82 and the second groove 83.

In the present specification, the expression that two elements are different from each other in three-dimensional shape does not only mean that the types of three-dimensional shapes (such as prismatic and cylindrical, for example) of the elements are different, but also mean that various dimensions (such as axial dimension, circumferential dimension, and radial dimension, for example) are different even with the same type of three-dimensional shape.

As illustrated in FIGS. 11 and 12, the first groove 82 and the second groove 83 are different from each other in maximum circumferential dimension. More specifically, as illustrated in FIGS. 11 and 12, the maximum circumferential dimension of the first groove 82 is larger than the maximum circumferential dimension of the second groove 83.

In the coil unit 70C, since the maximum circumferential dimension of the first groove 82 is larger than the maximum circumferential dimension of the second groove 83, it is made easier for the one end portion 41a side of a winding 41 to avoid the boundary between a first end face 81a and an inner peripheral surface 81d of a split yoke 81 when the one end portion 41a of the winding 41 is led out to a terminal portion 54. This makes it easier to prevent damage to insulating coating of the winding 41.

Moreover, in the coil unit 70C, since the maximum circumferential dimension of the first groove 82 is larger than the maximum circumferential dimension of the second groove 83, the distance between the first end face 81a of the split yoke 81 and the terminal portion 54 is easily ensured. This makes it easier to ensure the insulation between the split yoke 81 (split core 80C) and the terminal portion 54.

Furthermore, in the coil unit 70C, since the maximum circumferential dimension of the first groove 82 is larger than the maximum circumferential dimension of the second groove 83, when a housing (see FIG. 7) is attached to a stator having a plurality of coil units 70C arranged in an annular shape in the circumferential direction, a region where the part of the first end face 81a of the split yoke 81 where the first groove 82 is provided is separated from the housing becomes wider. This makes it easier to ensure the insulation between the split yoke 81 (split core 80C) and the housing.

### Embodiment 4

In a stator according to Embodiment 4 of the present disclosure, the maximum circumferential dimension of a first groove is smaller than the maximum circumferential dimension of a second groove.

The stator according to Embodiment 4 of the present disclosure may be the same as the stators according to Embodiments 1 to 3 of the present disclosure, except for the above point.

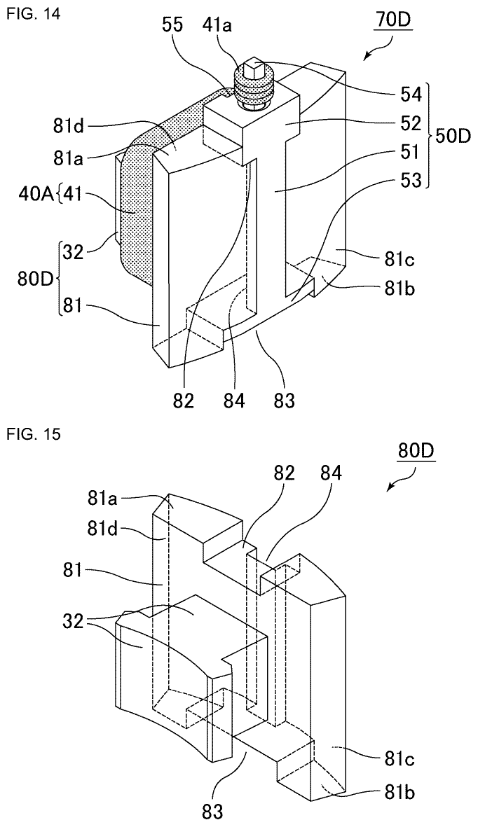

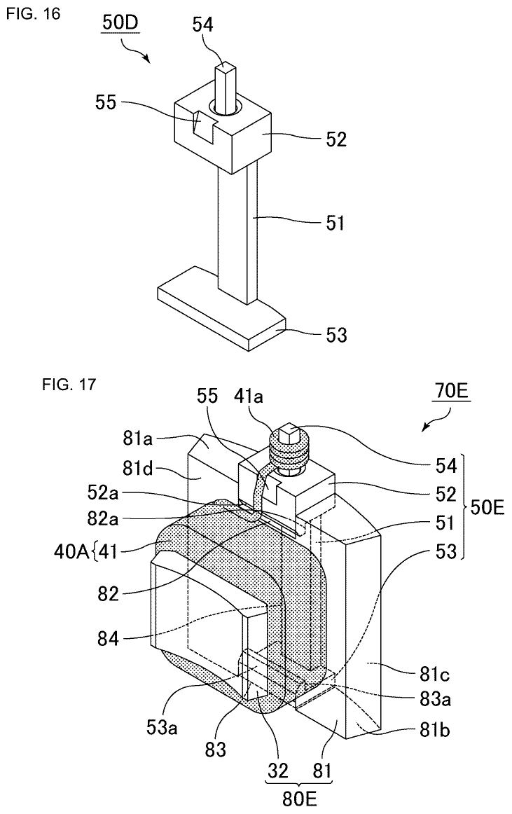

FIG. 14 is a schematic perspective view illustrating an example of a coil unit included in the stator according to Embodiment 4 of the present disclosure. FIG. 15 is a schematic perspective view illustrating a split core in FIG. 14. FIG. 16 is a schematic perspective view illustrating a terminal member in FIG. 14.

A coil unit 70D illustrated in FIG. 14 includes a split core 80D (see FIG. 15), a coil 40A, and a terminal member 50D (see FIG. 16).

As illustrated in FIGS. 14 and 15, the maximum circumferential dimension of a first groove 82 is smaller than the maximum circumferential dimension of a second groove 83.

### Embodiment 5

In a stator according to Embodiment 5 of the present disclosure, a first step portion is provided along the axial direction at the bottom of a first groove, so that the axial dimension of the first groove is smaller on the outer peripheral surface side of a yoke than on the inner peripheral surface side. A first fixed portion has a first protruding portion protruding in the axial direction. The first step portion is fitted to the first protruding portion.

In the stator according to Embodiment 5 of the present disclosure, a third step portion is provided along the axial direction at the bottom of a second groove, so that the axial dimension of the second groove is smaller on the outer peripheral surface side of the yoke than on the inner peripheral surface side. A second fixed portion has a third protruding portion protruding in the axial direction. The third step portion is fitted to the third protruding portion.

The stator according to Embodiment 5 of the present disclosure may be the same as the stators according to Embodiments 1 to 4 of the present disclosure, except for the above points.

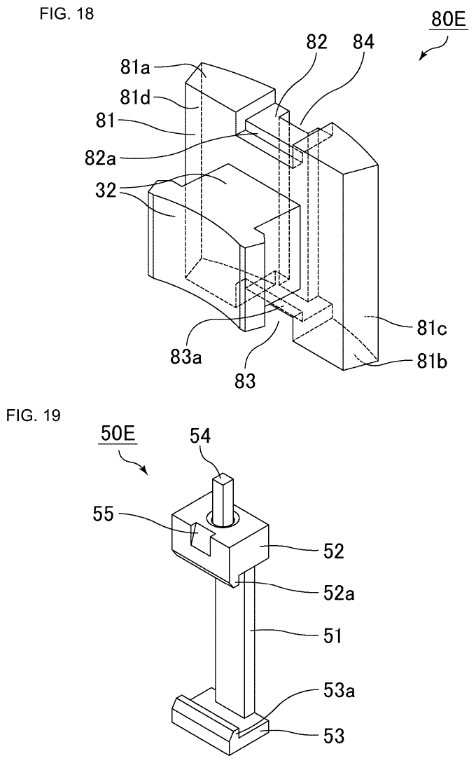

FIG. 17 is a schematic perspective view illustrating an example of a coil unit included in the stator according to Embodiment 5 of the present disclosure. FIG. 18 is a schematic perspective view illustrating a split core in FIG. 17. FIG. 19 is a schematic perspective view illustrating a terminal member in FIG. 17.

A coil unit 70E illustrated in FIG. 17 includes a split core 80E (see FIG. 18), a coil 40A, and a terminal member 50E (see FIG. 19).

As illustrated in FIGS. 17 and 18, a first step portion 82a is provided along the axial direction at the bottom of a first groove 82 (here, the bottom on the second groove 83 side in the axial direction) so that the axial dimension of the first groove 82 is smaller on the outer peripheral surface 81c side of a split yoke 81 than on the inner peripheral surface 81d side.

As illustrated in FIGS. 17 and 19, a first fixed portion 52 has a first protruding portion 52a that protrudes in the axial direction. In the example illustrated in FIGS. 17 and 19, the first protruding portion 52a protrudes in a claw-like shape from the radially innermost position of the first fixed portion 52 (here, the opposite side to a pillar portion 51) toward a second fixed portion 53 in the axial direction.

As illustrated in FIG. 17, the first step portion 82a is fitted to the first protruding portion 52a. This allows the first fixed portion 52 to be firmly fixed to the split yoke 81, and facilitates positioning of the first fixed portion 52 in the axial, circumferential, and radial directions.

As illustrated in FIGS. 17 and 18, a third step portion 83a is provided along the axial direction at the bottom of the second groove 83 (here, the bottom on the first groove 82 side in the axial direction) so that the axial dimension of the second groove 83 is smaller on the outer peripheral surface 81c side of the split yoke 81 than on the inner peripheral surface 81d side.

As illustrated in FIGS. 17 and 19, the second fixed portion 53 has a third protruding portion 53a that protrudes in the axial direction. In the example illustrated in FIGS. 17 and 19, the third protruding portion 53a protrudes in a claw-like shape from the radially innermost position (here, the opposite side to the pillar portion 51) of the second fixed portion 53 toward the first fixed portion 52 in the axial direction.

As illustrated in FIG. 17, the third step portion 83a is fitted to the third protruding portion 53a. This allows the second fixed portion 53 to be firmly fixed to the split yoke 81, and also facilitates positioning of the second fixed portion 53 in the axial, circumferential, and radial directions.

As described above, in the coil unit 70E, the first step portion 82a is fitted to the first protruding portion 52a, and the third step portion 83a is fitted to the third protruding portion 53a. This allows the terminal member 50E to be firmly fixed to the split yoke 81, and also facilitates positioning of the terminal member 50E in the axial, circumferential, and radial directions.

In the coil unit 70E, the first step portion 82a can be fitted to the first protruding portion 52a, and the third step portion 83a can be fitted to the third protruding portion 53a by simply pushing the terminal member 50E into the split yoke 81 from the outer peripheral surface 81c side of the split yoke 81. This improves work efficiency when attaching the terminal member 50E.

The number of steps of the first step portion 82a and the third step portion 83a may each be one step or a plurality of steps.

The number of steps of the first step portion 82a and the third step portion 83a may be the same or different from each other.

The three-dimensional shape of the first protruding portion 52a and the third protruding portion 53a is not limited to the three-dimensional shape illustrated in FIGS. 17 and 19.

When the first step portion 82a has a plurality of steps, the three-dimensional shape of the surface of the first protruding portion 52a may be a multi-step staircase shape along the surface of the first step portion 82a.

When the third step portion 83a has a plurality of steps, the three-dimensional shape of the surface of the third protruding portion 53a may be a multi-step staircase shape along the surface of the third step portion 83a.

The first protruding portion 52a and the third protruding portion 53a may be the same or different from each other in three-dimensional shape.

As a modification of the coil unit 70E, one of the fitted portion between the first step portion 82a and the first protruding portion 52a and the fitted portion between the third step portion 83a and the third protruding portion 53a does not have to be provided. For example, when the first groove 82 is provided with the first step portion 82a and the first fixed portion 52 has the first protruding portion 52a, the second groove 83 is not provided with the third step portion 83a and the second fixed portion 53 does not have to have the third protruding portion 53a. Alternatively, when the second groove 83 is provided with the third step portion 83a and the second fixed portion 53 has the third protruding portion 53a, the first groove 82 is not provided with the first step portion 82a and the first fixed portion 52 does not have to have the first protruding portion 52a.

### Embodiment 6

In a stator according to Embodiment 6 of the present disclosure, a second step portion is provided along the circumferential direction on a side portion of a first groove, so that the circumferential dimension of the first groove is smaller on the outer peripheral surface side of a yoke than on the inner peripheral surface side. A first fixed portion has a second protruding portion protruding in the circumferential direction. The second step portion is fitted to the second protruding portion.

In the stator according to Embodiment 6 of the present disclosure, a fourth step portion is provided along the circumferential direction on a side portion of a second groove, so that the circumferential dimension of the second groove is smaller on the outer peripheral surface side of the yoke than on the inner peripheral surface side. A second fixed portion has a fourth protruding portion protruding in the circumferential direction. The fourth step portion is fitted to the fourth protruding portion.

The stator according to Embodiment 6 of the present disclosure may be the same as the stators according to Embodiments 1 to 5 (including the modification) of the present disclosure, except for the above points.

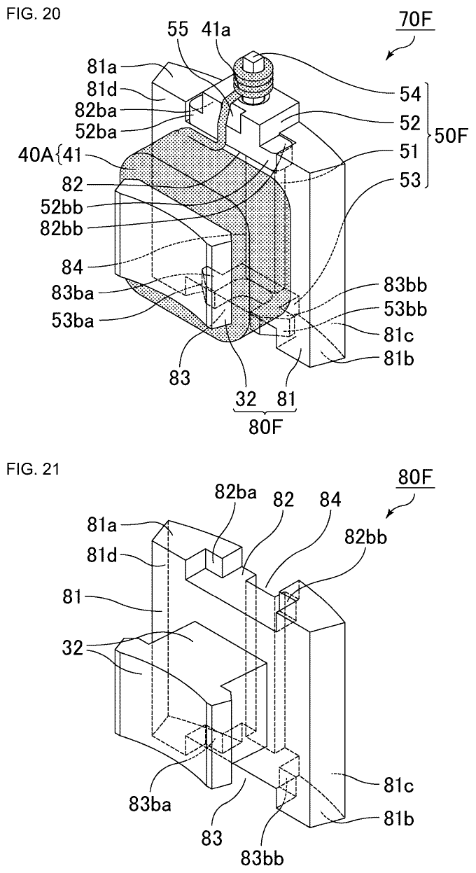

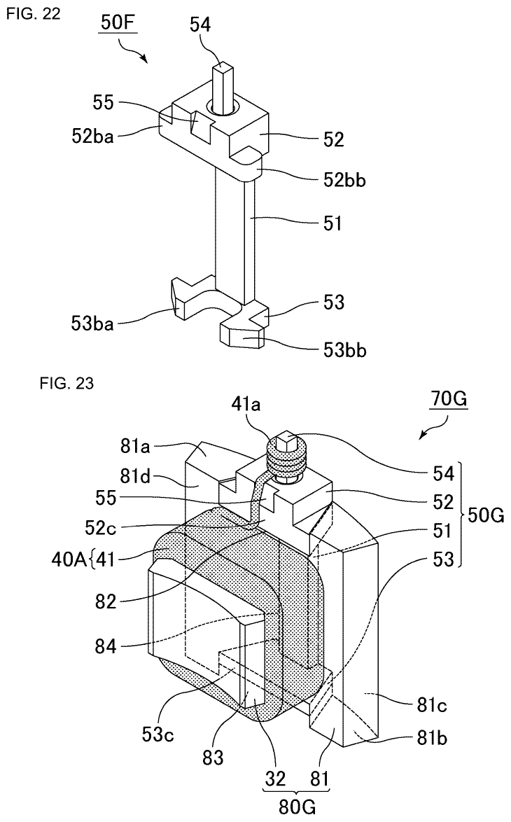

FIG. 20 is a schematic perspective view illustrating an example of a coil unit included in the stator according to Embodiment 6 of the present disclosure. FIG. 21 is a schematic perspective view illustrating a split core in FIG. 20. FIG. 22 is a schematic perspective view illustrating a terminal member in FIG. 20.

A coil unit 70F illustrated in FIG. 20 includes a split core 80F (see FIG. 21), a coil 40A, and a terminal member 50F (see FIG. 22).

As illustrated in FIGS. 20 and 21, a second step portion 82ba and a second step portion 82bb are provided on a side portion of a first groove 82 along the circumferential direction, so that the circumferential dimension of the first groove 82 is smaller on the outer peripheral surface 81c side of a split yoke 81 than on the inner peripheral surface 81d side.

As illustrated in FIGS. 20 and 22, a first fixed portion 52 has a second protruding portion 52ba and a second protruding portion 52bb, which protrude in the circumferential direction. In the example illustrated in FIGS. 20 and 22, the second protruding portions 52ba and 52bb protrude opposite to each other in the circumferential direction from the radially innermost position (here, the opposite side to the pillar portion 51) of the first fixed portion 52.

As illustrated in FIG. 20, the second step portion 82ba is fitted to the second protruding portion 52ba, and the second step portion 82bb is fitted to the second protruding portion 52bb. This allows the first fixed portion 52 to be firmly fixed to the split yoke 81, and also facilitates positioning of the first fixed portion 52 in the axial, circumferential, and radial directions.

As illustrated in FIGS. 20 and 21, a fourth step portion 83ba and a fourth step portion 83bb are provided on a side portion of a second groove 83 along the circumferential direction, so that the circumferential dimension of the second groove 83 is smaller on the outer peripheral surface 81c side of the split yoke 81 than on the inner peripheral surface 81d side.

As illustrated in FIGS. 20 and 22, a second fixed portion 53 has a fourth protruding portion 53ba and a fourth protruding portion 53bb, which protrude in the circumferential direction. In the example illustrated in FIGS. 20 and 22, the second fixed portion 53 has a snap-fit structure, and the fourth protruding portions 53ba and 53bb protrude opposite to each other in the circumferential direction from the innermost radial position (here, the opposite side to the pillar portion 51) of the second fixed portion 53.

As illustrated in FIG. 20, the fourth step portion 83ba is fitted to the fourth protruding portion 53ba, and the fourth step portion 83bb is fitted to the fourth protruding portion 53bb. This allows the second fixed portion 53 to be firmly fixed to the split yoke 81, and also facilitates positioning of the second fixed portion 53 in the axial, circumferential, and radial directions.

As described above, in the coil unit 70F, the second step portion 82ba is fitted to the second protruding portion 52ba, the second step portion 82bb is fitted to the second protruding portion 52bb, the fourth step portion 83ba is fitted to the fourth protruding portion 53ba, and the fourth step portion 83bb is fitted to the fourth protruding portion 53bb. This allows the terminal member 50F to be firmly fixed to the split yoke 81, and also facilitates positioning of the terminal member 50F in the axial, circumferential, and radial directions.

In the coil unit 70F, work efficiency when attaching the terminal member 50F is improved. In particular, since the second fixed portion 53 has the snap-fit structure in the coil unit 70F, the fourth step portion 83ba can be fitted to the fourth protruding portion 53ba, and the fourth step portion 83bb can be fitted to the fourth protruding portion 53bb by simply pushing the second fixed portion 53 into the split yoke 81 from the outer peripheral surface 81c side of the split yoke 81.

Furthermore, since the above fitting mode allows the terminal member 50F to be attached to the split yoke 81 in the coil unit 70F, the terminal member 50F is firmly fixed to the split yoke 81 even when the axial dimensions of the first groove 82 and the second groove 83 are smaller than those of the coil unit 70A (see FIGS. 2 and 3), for example. It is therefore possible to reduce the axial dimensions of the first groove 82 and the second groove 83 in the coil unit 70F. Even when the terminal member 50F is provided, the terminal member 50F is prevented from interfering with the coil 40A (winding 41). The terminal member 50F is thus prevented from reducing the space factor of the coil 40A (winding 41).

The number of steps of the second step portion 82ba, the second step portion 82bb, the fourth step portion 83ba, and the fourth step portion 83bb may each be one step or a plurality of steps.

The number of steps of the second step portion 82ba, the second step portion 82bb, the fourth step portion 83ba, and the fourth step portion 83bb may be the same, different or partially different from each other.

The three-dimensional shapes of the second protruding portion 52ba, the second protruding portion 52bb, the fourth protruding portion 53ba, and the fourth protruding portion 53bb are not limited to those illustrated in FIGS. 20 and 22.

When the second step portion 82ba has a plurality of steps, the three-dimensional shape of the surface of the second protruding portion 52ba may be a multi-step staircase shape along the surface of the second step portion 82ba.

When the second step portion 82bb has a plurality of steps, the three-dimensional shape of the surface of the second protruding portion 52bb may be a multi-step staircase shape along the surface of the second step portion 82bb.

When the fourth step portion 83ba has a plurality of steps, the three-dimensional shape of the surface of the fourth protruding portion 53ba may be a multi-step staircase shape along the surface of the fourth step portion 83ba.

When the fourth step portion 83bb has a plurality of steps, the three-dimensional shape of the surface of the fourth protruding portion 53bb may be a multi-step staircase shape along the surface of the fourth step portion 83bb.

The second protruding portion 52ba, the second protruding portion 52bb, the fourth protruding portion 53ba, and the fourth protruding portion 53bb may be the same, different or partially different from each other in three-dimensional shape.

As a modification of the coil unit 70F, up to three of the fitted portion between the second step portion 82ba and the second protruding portion 52ba, the fitted portion between the second step portion 82bb and the second protruding portion 52bb, the fitted portion between the fourth step portion 83ba and the fourth protruding portion 53ba, and the fitted portion between the fourth step portion 83bb and the fourth protruding portion 53bb do not have to be provided. For example, when the first groove 82 is provided with the second step portion 82ba and the second step portion 82bb and the first fixed portion 52 has the second protruding portion 52ba and the second protruding portion 52bb, the second groove 83 is not provided with the fourth step portion 83ba and the fourth step portion 83bb and the second fixed portion 53 does not have to have the fourth protruding portion 53ba and the fourth protruding portion 53bb.

### Embodiment 7

In a stator according to Embodiment 7 of the present disclosure, a first groove is tapered such that its circumferential dimension decreases from the inner peripheral surface side to the outer peripheral surface side of a yoke. A first fixed portion has a first tapered portion that is tapered such that its circumferential dimension decreases from the inner peripheral surface side to the outer peripheral surface side of the yoke. The first groove is fitted to the first tapered portion.

In the stator according to Embodiment 7 of the present disclosure, a second groove is tapered such that its circumferential dimension decreases from the inner peripheral surface side to the outer peripheral surface side of the yoke. A second fixed portion has a second tapered portion that is tapered such that its circumferential dimension decreases from the inner peripheral surface side to the outer peripheral surface side of the yoke. The second groove is fitted to the second tapered portion.

The stator according to Embodiment 7 of the present disclosure may be the same as the stator of Embodiments 1 to 5 (including the modification) of the present disclosure, except for the above points.

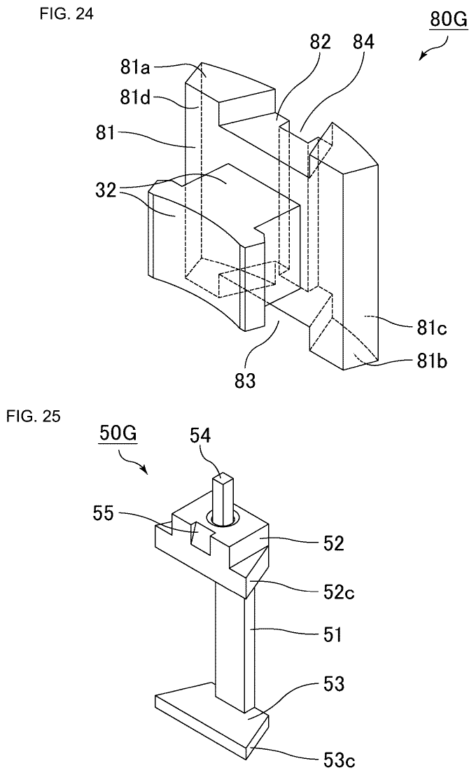

FIG. 23 is a schematic perspective view illustrating an example of a coil unit included in the stator according to Embodiment 7 of the present disclosure. FIG. 24 is a schematic perspective view illustrating a split core in FIG. 23. FIG. 25 is a schematic perspective view illustrating a terminal member in FIG. 23.

A coil unit 70G illustrated in FIG. 23 includes a split core 80G (see FIG. 24), a coil 40A, and a terminal member 50G (see FIG. 25).

As illustrated in FIGS. 23 and 24, a first groove 82 is tapered such that its circumferential dimension decreases from the inner peripheral surface 81d side to the outer peripheral surface 81c side of a split yoke 81.

As illustrated in FIGS. 23 and 25, a first fixed portion 52 has a first tapered portion 52c that is tapered such that its circumferential dimension decreases from the inner peripheral surface 81d side to the outer peripheral surface 81c side of the split yoke 81. In the example illustrated in FIGS. 23 and 25, the first fixed portion 52 has the first tapered portion 52c at a position on the second fixed portion 53 side in the axial direction.

As illustrated in FIG. 23, the first groove 82 is fitted to the first tapered portion 52c. This allows the first fixed portion 52 to be firmly fixed to the split yoke 81, and also facilitates positioning of the first fixed portion 52 in the axial, circumferential, and radial directions.

As illustrated in FIGS. 23 and 24, the second groove 83 is tapered such that its circumferential dimension decreases from the inner peripheral surface 81d side to the outer peripheral surface 81c side of the split yoke 81.

As illustrated in FIGS. 23 and 25, the second fixed portion 53 has a second tapered portion 53c that is tapered such that its circumferential dimension decreases from the inner peripheral surface 81d side to the outer peripheral surface 81c side of the split yoke 81. In the example illustrated in FIGS. 23 and 25, the second fixed portion 53 is formed of the second tapered portion 53c.

As illustrated in FIG. 23, the second groove 83 is fitted to the second tapered portion 53c. This allows the second fixed portion 53 to be firmly fixed to the split yoke 81, and also facilitates positioning of the second fixed portion 53 in the axial, circumferential, and radial directions.

As described above, the first groove 82 is fitted to the first tapered portion 52c, and the second groove 83 is fitted to the second tapered portion 53c in the coil unit 70G. This allows the terminal member 50G to be firmly fixed to the split yoke 81, and also facilitates positioning of the terminal member 50G in the axial, circumferential, and radial directions.

In the coil unit 70G, work efficiency when attaching the terminal member 50G is improved. From the viewpoint of work efficiency when attaching the terminal member 50G, a slit may be provided in the second tapered portion 53c, for example. The slit provided in the second tapered portion 53c makes the second tapered portion 53c (second fixed portion 53) more flexible, thus allowing the second groove 83 and the second tapered portion 53c to be easily fitted together. The slit may be provided, for example, in the circumferential direction or in the radial direction.

Moreover, since the above fitting mode allows the terminal member 50G to be attached to the split yoke 81 in the coil unit 70G, the terminal member 50G is firmly fixed to the split yoke 81 even when the axial dimensions of the first groove 82 and the second groove 83 are smaller than those of the coil unit 70A (see FIGS. 2 and 3), for example. It is therefore possible to reduce the axial dimensions of the first groove 82 and the second groove 83 in the coil unit 70G. Even when the terminal member 50G is provided, the terminal member 50G is prevented from interfering with the coil 40A (winding 41). The terminal member 50G is thus prevented from reducing the space factor of the coil 40A (winding 41).

Furthermore, the split core 80G of the coil unit 70G makes it easier to form the first groove 82 and the second groove 83 than the split core 80F (see FIG. 21) of the coil unit 70F.

The axial dimensions of the first groove 82 and the first tapered portion 52c may be the same or different from each other. When the axial dimensions of the first groove 82 and the first tapered portion 52c are different from each other, the axial dimension of the first groove 82 may be larger than the axial dimension of the first tapered portion 52c, or may be smaller than the axial dimension of the first tapered portion 52c.

The axial dimensions of the second groove 83 and the second tapered portion 53c may be the same or different from each other. When the axial dimensions of the second groove 83 and the second tapered portion 53c are different from each other, the axial dimension of the second groove 83 may be larger than the axial dimension of the second tapered portion 53c or may be smaller than the axial dimension of the second tapered portion 53c.

The three-dimensional shapes of the first groove 82 and the second groove 83 are not limited to the three-dimensional shapes illustrated in FIGS. 23 and 24, as long as they are tapered as described above.

The first groove 82 and the second groove 83 may be the same or different from each other in three-dimensional shape.

The three-dimensional shapes of the first tapered portion 52c and the second tapered portion 53c are not limited to the three-dimensional shapes illustrated in FIGS. 23 and 25, as long as they are tapered as described above.

The first tapered portion 52c and the second tapered portion 53c may be the same or different from each other in three-dimensional shape.

As a modification of the coil unit 70G, one of the fitted portion between the first groove 82 and the first tapered portion 52c and the fitted portion between the second groove 83 and the second tapered portion 53c does not have to be provided. For example, when the first groove 82 is tapered and the first fixed portion 52 has the first tapered portion 52c, the second groove 83 does not have to be tapered and the second fixed portion 53 does not have to have the second tapered portion 53c. Alternatively, when the second groove 83 is tapered and the second fixed portion 53 has the second tapered portion 53c, the first groove 82 does not have to be tapered and the first fixed portion 52 does not have to have the first tapered portion 52c.

### Embodiment 8

In a stator according to Embodiment 8 of the present disclosure, one of the bottom of a first groove and a first fixed portion is provided with a first concave portion recessed in the axial direction, and the other of the bottom of the first groove and the first fixed portion is provided with a first convex portion protruding in the axial direction. The first concave portion is fitted to the first convex portion.

In the stator according to Embodiment 8 of the present disclosure, one of the bottom of a second groove and a second fixed portion is provided with a second concave portion recessed in the axial direction, and the other of the bottom of the second groove and the second fixed portion is provided with a second convex portion protruding in the axial direction. The second concave portion is fitted to the second convex portion.

The stator according to Embodiment 8 of the present disclosure may be the same as the stators according to Embodiments 1 to 7 (including the modification) of the present disclosure, except for the above points.

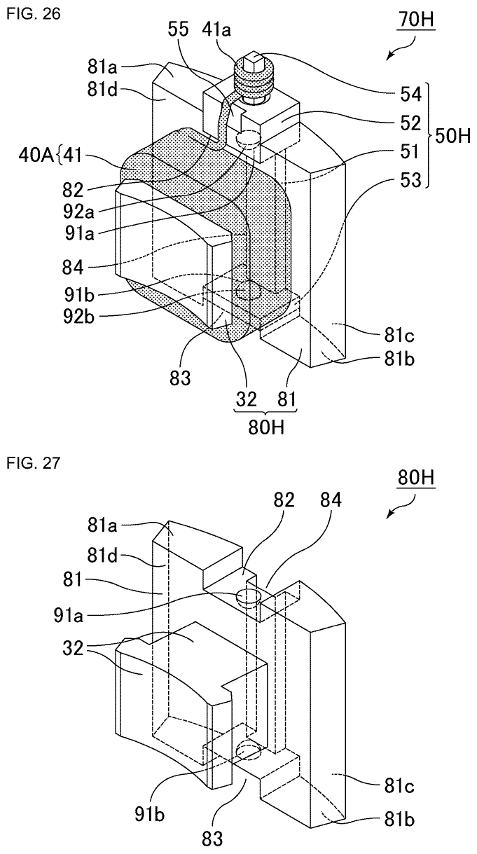

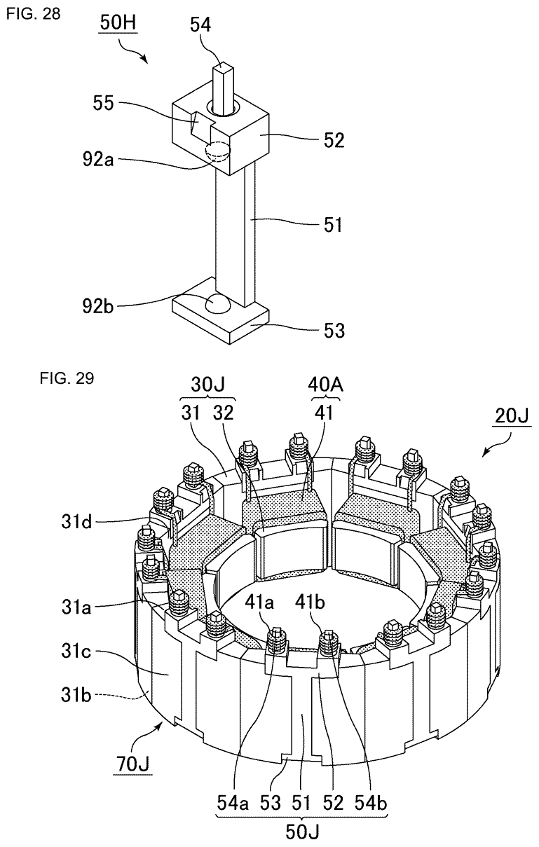

FIG. 26 is a schematic perspective view illustrating an example of a coil unit included in the stator according to Embodiment 8 of the present disclosure. FIG. 27 is a schematic perspective view illustrating a split core in FIG. 26. FIG. 28 is a schematic perspective view illustrating a terminal member in FIG. 26.

A coil unit 70H illustrated in FIG. 26 includes a split core 80H (see FIG. 27), a coil 40A, and a terminal member 50H (see FIG. 28).

As illustrated in FIGS. 26 and 27, a first concave portion 91a recessed in the axial direction is provided at the bottom of a first groove 82 (here, the bottom on the second groove 83 side in the axial direction). In the example illustrated in FIGS. 26 and 27, the first concave portion 91a is recessed in the axial direction from a position spaced apart from the periphery at the bottom of the first groove 82 toward the second groove 83.

As illustrated in FIGS. 26 and 28, the first fixed portion 52 is provided with a first convex portion 92a protruding in the axial direction. In the example illustrated in FIGS. 26 and 28, the first convex portion 92a protrudes in the axial direction from a position spaced apart from the periphery on the bottom surface (here, the surface on the second fixed portion 53 side) of the first fixed portion 52 toward the second fixed portion 53.

As illustrated in FIG. 26, the first concave portion 91a is fitted to the first convex portion 92a. This allows the first fixed portion 52 to be firmly fixed to the split yoke 81, and also facilitates positioning of the first fixed portion 52 in the axial, circumferential, and radial directions.

As illustrated in FIGS. 26 and 27, the bottom of the second groove 83 (here, the bottom on the first groove 82 side in the axial direction) is provided with a second concave portion 91b recessed in the axial direction. In the example illustrated in FIGS. 26 and 27, the second concave portion 91b is recessed in the axial direction from a position spaced apart from the periphery at the bottom of the second groove 83 toward the first groove 82.

As illustrated in FIGS. 26 and 28, the second fixed portion 53 is provided with a second convex portion 92b protruding in the axial direction. In the example illustrated in FIGS. 26 and 28, the second convex portion 92b protrudes in the axial direction from a position spaced apart from the periphery on the top surface (here, the surface on the first fixed portion 52 side) of the second fixed portion 53 toward the first fixed portion 52.

As illustrated in FIG. 26, the second concave portion 91b is fitted to the second convex portion 92b. This allows the second fixed portion 53 to be firmly fixed to the split yoke 81, and also facilitates positioning of the second fixed portion 53 in the axial, circumferential, and radial directions.

As described above, in the coil unit 70H, the first concave portion 91a is fitted to the first convex portion 92a, and the second concave portion 91b is fitted to the second convex portion 92b. This allows the terminal member 50H to be firmly fixed to the split yoke 81, and also facilitates positioning of the terminal member 50H in the axial, circumferential, and radial directions.

In the coil unit 70H, the first concave portion 91a can be fitted to the first convex portion 92a, and the second concave portion 91b can be fitted to the second convex portion 92b by simply pushing the terminal member 50H into the split yoke 81 from the outer peripheral surface 81c side of the split yoke 81. This improves work efficiency when attaching the terminal member 50H.

Furthermore, since the above fitting mode allows the terminal member 50H to be attached to the split yoke 81 in the coil unit 70H, the terminal member 50H is firmly fixed to the split yoke 81 even when the axial dimensions of the first groove 82 and the second groove 83 are smaller than those of the coil unit 70A (see FIGS. 2 and 3), for example. It is therefore possible to reduce the axial dimensions of the first groove 82 and the second groove 83 in the coil unit 70H. Even when the terminal member 50H is provided, the terminal member 50H is prevented from interfering with the coil 40A (winding 41). The terminal member 50H is thus prevented from reducing the space factor of the coil 40A (winding 41).

The three-dimensional shapes of the first concave portion 91a and the second concave portion 91b are not limited to those illustrated in FIGS. 26 and 27.

The first concave portion 91a and the second concave portion 91b may be the same or different from each other in three-dimensional shape.

The three-dimensional shapes of the first convex portion 92a and the second convex portion 92b are not limited to the three-dimensional shapes illustrated in FIGS. 26 and 28.

The first convex portion 92a and the second convex portion 92b may be the same or different from each other in three-dimensional shape.

One or more than one fitted portion between the first concave portion 91a and the first convex portion 92a may be provided for the combination of the first groove 82 and the first fixed portion 52. Specifically, the number of the first concave portions 91a and the first convex portions 92a may each be one, or the same number of the first concave portions 91a and the first convex portions 92a may each be provided.

When a plurality of fitted portions between the first concave portions 91a and the first convex portions 92a are provided, the positional relationship is not particularly limited between the plurality of fitted portions. The fitted portions may be provided, for example, so as to be spaced apart in the circumferential direction or in the radial direction.

One or more than one fitted portion between the second concave portion 91b and the second convex portion 92b may be provided for the combination of the second groove 83 and the second fixed portion 53. Specifically, the number of the second concave portions 91b and the second convex portions 92b may each be one, or the same number of the second concave portions 91b and the second convex portions 92b may each be provided.

When a plurality of fitted portions between the second concave portions 91b and the second convex portions 92b are provided, the positional relationship is not particularly limited between the plurality of fitted portions. The fitted portions may be provided, for example, so as to be spaced apart in the circumferential direction or in the radial direction.

As a modification of the coil unit 70H, the first concave portion 91a may be provided in the first fixed portion 52 instead of the bottom of the first groove 82, and the first convex portion 92a may be provided at the bottom of the first groove 82 instead of the first fixed portion 52.

As a modification of the coil unit 70H, the second concave portion 91b may be provided in the second fixed portion 53 instead of the bottom of the second groove 83, and the second convex portion 92b may be provided at the bottom of the second groove 83 instead of the second fixed portion 53.

As a modification of the coil unit 70H, one of the fitted portion between the first concave portion 91a and the first convex portion 92a and the fitted portion between the second concave portion 91b and the second convex portion 92b does not have to be provided. For example, when the first concave portion 91a is provided at the bottom of the first groove 82 and the first convex portion 92a is provided on the first fixed portion 52, the second concave portion 91b does not have to be provided at the bottom of the second groove 83, and the second convex portion 92b does not have to be provided on the second fixed portion 53. Alternatively, when the second concave portion 91b is provided at the bottom of the second groove 83 and the second convex portion 92b is provided on the second fixed portion 53, the first concave portion 91a does not have to be provided at the bottom of the first groove 82 and the first convex portion 92a does not have to be provided on the first fixed portion 52.

### Embodiment 9

In a stator according to Embodiment 9 of the present disclosure, a terminal member has two terminal portions.

In the stator according to Embodiment 9 of the present disclosure, one end portion of a winding is fixed in a state of being wound around one of the two terminal portions, and the other end portion of the winding is fixed in a state of being wound around the other of the two terminal portions.

The stator according to Embodiment 9 of the present disclosure may be the same as the stators according to Embodiments 1 to 8 (including the modification) of the present disclosure, except for the above points.

FIG. 29 is a schematic perspective view illustrating an example of the stator according to Embodiment 9 of the present disclosure.

A stator 20J illustrated in FIG. 29 includes a stator core 30J, a plurality of coils 40A, and a plurality of terminal members 50J.

The stator 20J includes a plurality of coil units 70J arranged in an annular shape in the circumferential direction.

In the stator 20J, windings 41 of the plurality of coils 40A are connected in parallel, for example.

In the stator 20J, the plurality of coils 40A include, in the case of a three-phase coil, for example, a coil including a U-phase winding, a coil including a V-phase winding, and a coil including a W-phase winding. In this case, the U-phase winding, the V-phase winding, and the W-phase winding are star-connected or delta-connected.

The plurality of terminal members 50J each include a pillar portion 51, a first fixed portion 52, a second fixed portion 53, a terminal portion 54a, and a terminal portion 54b.

The terminal portions 54a and 54b are provided on the first fixed portion 52 so as to protrude from the first fixed portion 52 at positions spaced apart from each other in the circumferential direction.

The terminal portions 54a and 54b may be made of the same material or different materials from each other.

The terminal portions 54a and 54b may be the same or different from each other in three-dimensional shape.

One end portion 41a of the winding 41 is fixed in a state of being wound around the terminal portion 54a. This allows the one end portion 41a of the winding 41 to be led out to the terminal member 50J.

The other end portion 41b of the winding 41 is fixed in a state of being wound around the terminal portion 54b. This allows the other end 41b of the winding 41 to be led out to the terminal member 50J.

The stator 20J may include at least one coil 40A, among the plurality of coils 40A, in which one end portion 41a of the winding 41 is fixed in a state of being wound around the terminal portion 54a and the other end portion 41b of the winding 41 is fixed in a state of being wound around the terminal portion 54b. Specifically, for all of the plurality of coils 40A, one end portion 41a of the winding 41 may be fixed in a state of being wound around the terminal portion 54a and the other end portion 41b of the winding 41 may be fixed in a state of being wound around the terminal portion 54b. Alternatively, for some of the coils 40A, one end portion 41a of the winding 41 may be fixed in a state of being wound around the terminal portion 54a and the other end portion 41b of the winding 41 may be fixed in a state of being wound around the terminal portion 54b. When, for some of the plurality of coils 40A, one end portion 41a of the winding 41 is fixed in a state of being wound around the terminal portion 54a and the other end portion 41b of the winding 41 is fixed in a state of being wound around the terminal portion 54b, at least one of the one end portion 41a and the other end portion 41b of the winding 41 does not have to be fixed in a state of being wound around the terminal portion for the rest of the coils 40A.

In the above embodiment, the stator core has a split structure in which the stator core is divided into split cores. However, in the stator of the present disclosure, the stator core may have a non-split integral structure.

In a stator with a stator core having a split structure, the coils can be arranged more densely than in a stator with a stator core having an integral structure, making it possible to increase the number of coils. Therefore, the stator with the stator core having the split structure makes it easier to improve the characteristics of a motor, compared to the stator with the stator core having the integral structure.

In the above embodiment, the first end face of the yoke is fitted to the first fixed portion, and the second end face of the yoke is fitted to the second fixed portion. However, in the stator of the present disclosure, the fitting mode between the first end face of the yoke and the first fixed portion may be the same as or different from the fitting mode between the second end face of the yoke and the second fixed portion. When the fitting mode between the first end face of the yoke and the first fixed portion is different from the fitting mode between the second end face of the yoke and the second fixed portion in the stator of the present disclosure, the mode in which the tapered first groove provided in the first end face of the yoke is fitted to the first tapered portion of the first fixed portion (see Embodiment 7) may be combined with the mode in which the third step portion at the bottom of the second groove provided in the second end face of the yoke is fitted to the third protruding portion of the second fixed portion (see Embodiment 5).

In the above embodiment, the first groove provided in the first end face of the yoke is fitted to the first fixed portion of the terminal member, and the second groove provided in the second end face of the yoke is fitted to the second fixed portion of the terminal member. However, in the stator of the present disclosure, at least one of the first groove and the second groove does not have to be provided in the yoke. When the yoke is not provided with both the first groove and the second groove in the stator of the present disclosure, the terminal member may simply sandwich the yoke in the axial direction.

The stator of the present disclosure may be used not only as a component of a motor to be described later, but also as a component of a generator, for example.

### Motor

A motor of the present disclosure includes the stator of the present disclosure and a rotor provided facing an inner peripheral surface of the stator.

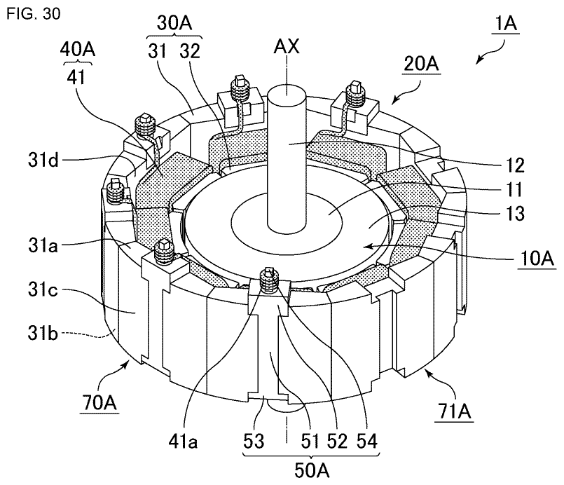

FIG. 30 is a schematic perspective view illustrating an example of the motor of the present disclosure.

A motor 1A illustrated in FIG. 30 includes a rotor 10A and the stator 20A.

In the motor 1A, the rotor 10A is located coaxially on the inner side and the stator 20A is located coaxially on the outer side with respect to an axis AX. The axis AX corresponds to a rotation axis of the rotor 10A.

The rotor 10A is provided facing the inner peripheral surface of the stator 20A.

The rotor 10A includes a rotor yoke 11, a shaft 12, and a permanent magnet 13, for example.

The rotor yoke 11 is made of, for example, a bulk soft magnetic body, an electromagnetic steel sheet, a powder magnetic core, a resin molded body containing a soft magnetic material, or the like.

The shaft 12 is inserted into the rotor yoke 11.

The material of the shaft 12 may be, for example, metal such as stainless steel.

The direction in which the shaft 12 extends, that is, the direction in which the axis AX extends, is parallel to the axial direction.

The permanent magnet 13 is provided such that N poles and S poles are arranged alternately along the outer peripheral surface of the rotor yoke 11.

When viewed from the axial direction, the rotor 10A may be substantially circular or substantially polygonal.

In this embodiment, the motor includes the stator 20A in which a plurality of coil units 70A are arranged in an annular shape in the circumferential direction. However, the same applies to a motor including a stator in which other coil units such as the coil unit 70B are arranged in an annular shape in the circumferential direction.

The motor of the present disclosure may further include a connection board electrically connected to one end portion of the winding.

The connection board may be provided with a plurality of through-holes that penetrate between one main surface and the other main surface and are spaced apart from each other in the circumferential direction.

In the connection board, a terminal may be exposed on an inner wall surface of each through-hole.

The connection board may be placed in the axial direction relative to the stator so that the terminal portions (see FIG. 1) of the plurality of terminal members of the stator pass through separate through-holes.

When the connection board described above is placed in the axial direction relative to the stator, the one end portion of the winding wound around the terminal portion of the terminal member can be efficiently connected to the terminal exposed from the inner wall surface of the through-hole in the connection board. Therefore, the motor having the connection board described above can easily achieve electrical connection between the one end portion of the winding and the terminal of the connection board.

The motor of the present disclosure may further include a housing (see FIG. 7) for protecting the stator core of the stator.

When the motor includes the connection board and the housing, the connection board may be provided inside the housing or outside the housing.

The present specification discloses the following.

<1>A stator including: a stator core that includes an annular yoke along a circumferential direction and a tooth protruding from an inner peripheral surface of the yoke in a radial direction of the yoke, the yoke having a first end face and a second end face facing each other in an axial direction of the stator core, and the stator core comprising a compact of magnetic powder; a coil comprising a winding wound around the tooth; and a terminal member including a pillar portion extending in the axial direction of the stator core, a first fixed portion at a first end of the pillar portion in the axial direction and protruding toward an inner peripheral surface side of the yoke more than the pillar portion in the radial direction, a second fixed portion at a second end of the pillar portion in the axial direction and protruding toward the inner peripheral surface side of the yoke more than the pillar portion in the radial direction, and a terminal portion on the first fixed portion and protruding from the first fixed portion, wherein the terminal member sandwiches the yoke in the axial direction so that the pillar portion faces an outer peripheral surface of the yoke in the radial direction, the first fixed portion faces the first end face of the yoke, and the second fixed portion faces the second end face of the yoke, and a first end of the winding is wound around the terminal portion.

<2>The stator according to <1>, in which the first end face of the yoke is fitted to the first fixed portion.

<3>The stator according to <2>, in which the first end face of the yoke includes a first groove that is open on an outer peripheral surface side of the yoke in the radial direction, and the first groove is fitted to the first fixed portion.

<4>The stator according to <3>, in which the first fixed portion protrudes from the first groove in the axial direction.

<5>The stator according to <3>, in which the first fixed portion fits inside the first groove in the axial direction.

<6>The stator according to any one of <3>to <5>, in which a bottom of the first groove includes a first step portion along the axial direction so that an axial dimension of the first groove is smaller on the outer peripheral surface side of the yoke than on the inner peripheral surface side of the yoke, the first fixed portion has a first protruding portion protruding in the axial direction, and the first step portion is fitted to the first protruding portion.

<7>The stator according to any one of <3>to <6>, in which a side portion of the first groove includes a second step portion along the circumferential direction so that a circumferential dimension of the first groove is smaller on the outer peripheral surface side of the yoke than on the inner peripheral surface side of the yoke, the first fixed portion has a second protruding portion protruding in the circumferential direction, and the second step portion is fitted to the second protruding portion.

<8>The stator according to any one of <3>to <6>, in which the first groove is tapered such that a circumferential dimension decreases from the inner peripheral surface side to the outer peripheral surface side of the yoke, the first fixed portion has a first tapered portion that is tapered such that a circumferential dimension thereof decreases from the inner peripheral surface side to the outer peripheral surface side of the yoke, and the first groove is fitted to the first tapered portion.

<9>The stator according to any one of <3>to <8>, in which one of a bottom of the first groove and the first fixed portion includes a first concave portion recessed in the axial direction, another of the bottom of the first groove and the first fixed portion includes a first convex portion protruding in the axial direction, and the first concave portion is fitted to the first convex portion.

<10>The stator according to any one of <1>to <9>, in which the second end face of the yoke is fitted to the second fixed portion.

<11>The stator according to <10>, in which the second end face of the yoke includes a second groove that is open on an outer peripheral surface side of the yoke in the radial direction, and the second groove is fitted to the second fixed portion.

<12>The stator according to <11>, in which a bottom of the second groove includes a third step portion along the axial direction so that an axial dimension of the second groove is smaller on the outer peripheral surface side of the yoke than on the inner peripheral surface side of the yoke, the second fixed portion has a third protruding portion protruding in the axial direction, and the third step portion is fitted to the third protruding portion.

<13>The stator according to <11>or <12>, in which a side portion of the second groove includes a fourth step portion along the circumferential direction so that a circumferential dimension of the second groove is smaller on the outer peripheral surface side of the yoke than on the inner peripheral surface side of the yoke, the second fixed portion has a fourth protruding portion protruding in the circumferential direction, and the fourth step portion is fitted to the fourth protruding portion.

<14>The stator according to <11>or <12>, in which the second groove is tapered such that a circumferential dimension decreases from the inner peripheral surface side to the outer peripheral surface side of the yoke, the second fixed portion has a second tapered portion that is tapered such that a circumferential dimension thereof decreases from the inner peripheral surface side to the outer peripheral surface side of the yoke, and the second groove is fitted to the second tapered portion.

<15>The stator according to any one of <11>to <14>, in which one of a bottom of the second groove and the second fixed portion includes a second concave portion recessed in the axial direction, another of the bottom of the second groove and the second fixed portion includes a second convex portion protruding in the axial direction, and the second concave portion is fitted to the second convex portion.

<16>The stator according to <1>, in which the first end face of the yoke includes a first groove that is open on an outer peripheral surface side of the yoke in the radial direction, the first groove is fitted to the first fixed portion, the second end face of the yoke includes a second groove that is open on the outer peripheral surface side of the yoke in the radial direction, the second groove is fitted to the second fixed portion, and the first groove and the second groove are different from each other in three-dimensional shape.

<17>The stator according to <16>, in which maximum dimensions in the circumferential direction of the first groove and the second groove are different from each other.

<18>The stator according to <17>, in which the maximum dimension in the circumferential direction of the first groove is larger than the maximum dimension in the circumferential direction of the second groove.

<19>The stator according to any one of <1>to <18>, in which the first fixed portion includes a guide groove, and the winding extends toward the terminal portion so as to pass through the guide groove.

<20>The stator according to any one of <1>to <19>, in which the outer peripheral surface of the yoke includes a third groove extending in the axial direction, and the third groove is fitted to the pillar portion.

<21>The stator according to any one of <1>to <20>, in which a plurality of coil units are arranged in an annular shape in the circumferential direction, and the plurality of coil units each include a portion of the stator core, the coil, and the terminal member.

<22>The stator according to any one of <1>to <21>, in which the stator core comprises a powder magnetic core.

<23>A motor including: the stator according to any one of <1>to <22>; and a rotor facing an inner peripheral surface of the stator.

### REFERENCE SIGNS LIST

1A MOTOR
10A ROTOR
11 ROTOR YOKE
12 SHAFT
13 PERMANENT MAGNET
20A, 20J STATOR
30A, 30J STATOR CORE
31 YOKE
31a FIRST END FACE OF YOKE
31b SECOND END FACE OF YOKE
31c OUTER PERIPHERAL SURFACE OF YOKE
31d INNER PERIPHERAL SURFACE OF YOKE
32 TOOTH
40A COIL
41 WINDING
41a ONE END PORTION OF WINDING
41b THE OTHER END PORTION OF WINDING
50A, 50B, 50C, 50D, 50E, 50F, 50G, 50H, 50J TERMINAL MEMBER
51 PILLAR PORTION
52 FIRST FIXED PORTION
52a FIRST PROTRUDING PORTION
52ba, 52bb SECOND PROTRUDING PORTION
52c FIRST TAPERED PORTION
53 SECOND FIXED PORTION
53a THIRD PROTRUDING PORTION
53ba, 53bb FOURTH PROTRUDING PORTION
53c SECOND TAPERED PORTION
54, 54a, 54b TERMINAL PORTION
55 GUIDE GROOVE
70A, 70B, 70C, 70D, 70E, 70F, 70G, 70H, 70J, 71A COIL UNIT
80A, 80C, 80D, 80E, 80F, 80G, 80H SPLIT CORE
81 SPLIT YOKE
81a FIRST END FACE OF SPLIT YOKE
81b SECOND END FACE OF SPLIT YOKE
81c OUTER PERIPHERAL SURFACE OF SPLIT YOKE
81d INNER PERIPHERAL SURFACE OF SPLIT YOKE
82 First groove
82a FIRST STEP PORTION
82ba, 82bb SECOND STEP PORTION
83 SECOND GROOVE
83a THIRD STEP PORTION
83ba, 83bb FOURTH STEP PORTION
84 THIRD GROOVE
91a FIRST CONCAVE PORTION
91b SECOND CONCAVE PORTION
92a FIRST CONVEX PORTION
92b SECOND CONVEX PORTION
100 HOUSING
AX AXIS

1. A stator comprising:
a stator core that includes an annular yoke along a circumferential direction and a tooth protruding from an inner peripheral surface of the yoke in a radial direction of the yoke, the yoke having a first end face and a second end face facing each other in an axial direction of the stator core, and the stator core comprising a compact of magnetic powder;
a coil comprising a winding wound around the tooth; and
a terminal member including a pillar portion extending in the axial direction of the stator core, a first fixed portion at a first end of the pillar portion in the axial direction and protruding toward an inner peripheral surface side of the yoke more than the pillar portion in the radial direction, a second fixed portion at a second end of the pillar portion in the axial direction and protruding toward the inner peripheral surface side of the yoke more than the pillar portion in the radial direction, and a terminal portion on the first fixed portion and protruding from the first fixed portion, wherein
the terminal member sandwiches the yoke in the axial direction so that the pillar portion faces an outer peripheral surface of the yoke in the radial direction, the first fixed portion faces the first end face of the yoke, and the second fixed portion faces the second end face of the yoke, and
a first end of the winding is wound around the terminal portion.

2. The stator according to claim 1, wherein the coil is wound around the tooth between the first end face of the yoke and the second end face of the yoke in the axial direction.

3. The stator according to claim 1, wherein the first end face of the yoke is fitted to the first fixed portion.

4. The stator according to claim 3, wherein the first end face of the yoke includes a first groove that is open on an outer peripheral surface side of the yoke in the radial direction, and the first groove is fitted to the first fixed portion.

5. The stator according to claim 4, wherein the first fixed portion protrudes from the first groove in the axial direction.

6. The stator according to claim 4, wherein the first fixed portion fits inside the first groove in the axial direction.

7. The stator according to claim 4, wherein
a bottom of the first groove includes a first step portion along the axial direction so that an axial dimension of the first groove is smaller on the outer peripheral surface side of the yoke than on the inner peripheral surface side of the yoke,
the first fixed portion has a first protruding portion protruding in the axial direction, and
the first step portion is fitted to the first protruding portion.

8. The stator according to claim 4, wherein
a side portion of the first groove includes a second step portion along the circumferential direction so that a circumferential dimension of the first groove is smaller on the outer peripheral surface side of the yoke than on the inner peripheral surface side of the yoke,
the first fixed portion has a second protruding portion protruding in the circumferential direction, and
the second step portion is fitted to the second protruding portion.

9. The stator according to claim 4, wherein
the first groove is tapered such that a circumferential dimension decreases from the inner peripheral surface side to the outer peripheral surface side of the yoke,
the first fixed portion has a first tapered portion that is tapered such that a circumferential dimension thereof decreases from the inner peripheral surface side to the outer peripheral surface side of the yoke, and
the first groove is fitted to the first tapered portion.

10. The stator according to claim 4, wherein
one of a bottom of the first groove and the first fixed portion includes a first concave portion recessed in the axial direction,
another of the bottom of the first groove and the first fixed portion includes a first convex portion protruding in the axial direction, and
the first concave portion is fitted to the first convex portion.

11. The stator according to claim 1, wherein the second end face of the yoke is fitted to the second fixed portion.

12. The stator according to claim 11, wherein
the second end face of the yoke includes a second groove that is open on an outer peripheral surface side of the yoke in the radial direction, and
the second groove is fitted to the second fixed portion.

13. The stator according to claim 12, wherein
a bottom of the second groove includes a third step portion along the axial direction so that an axial dimension of the second groove is smaller on the outer peripheral surface side of the yoke than on the inner peripheral surface side of the yoke,
the second fixed portion has a third protruding portion protruding in the axial direction, and
the third step portion is fitted to the third protruding portion.

14. The stator according to claim 12, wherein
a side portion of the second groove includes a fourth step portion along the circumferential direction so that a circumferential dimension of the second groove is smaller on the outer peripheral surface side of the yoke than on the inner peripheral surface side of the yoke,
the second fixed portion has a fourth protruding portion protruding in the circumferential direction, and
the fourth step portion is fitted to the fourth protruding portion.

15. The stator according to claim 12, wherein
the second groove is tapered such that a circumferential dimension decreases from the inner peripheral surface side to the outer peripheral surface side of the yoke,
the second fixed portion has a second tapered portion that is tapered such that a circumferential dimension thereof decreases from the inner peripheral surface side to the outer peripheral surface side of the yoke, and
the second groove is fitted to the second tapered portion.

16. The stator according to claim 12, wherein
one of a bottom of the second groove and the second fixed portion includes a second concave portion recessed in the axial direction,
another of the bottom of the second groove and the second fixed portion includes a second convex portion protruding in the axial direction, and
the second concave portion is fitted to the second convex portion.

17. The stator according to claim 1, wherein
the first end face of the yoke includes a first groove that is open on an outer peripheral surface side of the yoke in the radial direction,
the first groove is fitted to the first fixed portion,
the second end face of the yoke includes a second groove that is open on the outer peripheral surface side of the yoke in the radial direction,
the second groove is fitted to the second fixed portion, and
the first groove and the second groove are different from each other in three-dimensional shape.

18. The stator according to claim 17, wherein maximum dimensions in the circumferential direction of the first groove and the second groove are different from each other.

19. The stator according to claim 18, wherein the maximum dimension in the circumferential direction of the first groove is larger than the maximum dimension in the circumferential direction of the second groove.

20. The stator according to claim 1, wherein
the first fixed portion includes a guide groove, and
the winding extends toward the terminal portion so as to pass through the guide groove.

21. The stator according to claim 1, wherein
the outer peripheral surface of the yoke includes a third groove extending in the axial direction, and
the third groove is fitted to the pillar portion.

22. The stator according to claim 1, wherein
a plurality of coil units arranged in an annular shape in the circumferential direction, and
the plurality of coil units each include a portion of the stator core, the coil, and the terminal member.

23. The stator according to claim 1, wherein the stator core comprises a powder magnetic core.

24. A motor comprising:
the stator according to claim 1; and
a rotor facing an inner peripheral surface of the stator.
